(19) United States
(12) Patent Application Publication
(10) Pub. No.: US 2025/0317526 A1
(43) Pub. Date: Oct. 9, 2025

(54) PRINTING SYSTEM

(71) Applicant: CANON KABUSHIKI KAISHA, Tokyo (JP)

(72) Inventor: KOICHIRO MANABE, Kanagawa (JP)

(21) Appl. No.: 19/169,487

(22) Filed: Apr. 3, 2025

(30) Foreign Application Priority Data
Apr. 9, 2024 (JP) 2024-062894

(51) Int. Cl. H04N 1/60; G03G 15/00; H04N 1/23

(52) U.S. Cl. CPC H04N 1/6033; G03G 15/5016; G03G 15/5029; G03G 15/5062; G03G 15/5087; H04N 1/2323; H04N 1/2338

(57) ABSTRACT

An information processing apparatus includes a unit configured to instruct that instructs, based on an instruction by a user, an image forming apparatus to detect a paper characteristic of paper to be fed by using a unit configured to detect a paper characteristic of the image forming apparatus, to print a chart in which a color patch is disposed, and to perform colorimetry on the color patch, a unit configured to receive that receives, from the image forming apparatus, the detected paper characteristic and a result of the colorimetry, and a unit configured to register that creates, based on the result of the colorimetry, a color profile for adjustment of a color to be printed by the image forming apparatus, associates the detected paper characteristic and the color profile with each other, and resisters the paper characteristic and the color profile associated with each other.

### BACKGROUND

### Field of the Disclosure

The present disclosure relates to a printing system, an information processing apparatus, a processing method for the printing system, a processing method for the information processing apparatus, and a storage medium.

### Description of the Related Art

Characteristic information such as the thickness and the surface property of a medium such as paper is important as control parameters in an image forming apparatus in which an electrostatic latent image formed on a photosensitive member with laser light is developed with toner to form a toner image, and the formed toner image is transferred onto paper and fixed by heat. When the characteristic information of the medium is used, a fixing temperature and a conveyance speed optimum for the paper can be realized. It is generally known that the characteristic information of the paper is set by an operation of a user from a driver screen or an operation unit provided in the image forming apparatus.

In recent years, a configuration in which a sensor configured to detect the characteristics of a medium (hereinafter, referred to as a medium sensor) is provided in the image forming apparatus has been proposed. This improves convenience by, for example, eliminating the need for the operation by the user. For example, a medium sensor configured to detect the characteristics of the paper on a conveying path of the image forming apparatus is disposed to perform detection on the paper being fed during printing so as to allow setting and registration of the detected characteristics of the paper as paper information.

Furthermore, in a commercial printing field, a high-quality printing output result is demanded. Thus, a color profile for conversion into signals of a CMYK color space of the image forming apparatus with respect to a color space of an image to be input can be registered for each characteristic of the paper.

Japanese Patent Laid-Open No. 2006-218803 discloses a method for applying existing profiles to types of paper on a type-by-type basis.

The color profile is created, for example, by the following method: a chart in which color patches corresponding to object colors are disposed is printed for paper being an object of the creation of the color profile; a color value is measured for each color patch with a colorimeter; the object color is compared with a measured value. Hereinafter, this colorimeter is referred to as a colorimetric sensor.

In recent years, a configuration has been proposed in which the colorimetric sensor configured to measure the color patch disposed in the paper is provided in the image forming apparatus. Thus, operation from the measurement with the colorimetric sensor to the creation of the color profile can be automatically executed only by printing the color patch. Thus, convenience is improved by, for example, eliminating the need for the operation by the user.

When measurement is performed with the medium sensor during the printing, the paper characteristics can be automatically registered as the paper information. In addition, when the color patch is printed on the object paper and measured by the colorimetric sensor, the color profile can be automatically created on a paper characteristic-by-paper characteristic basis.

According to the related art, the color profile is created for paper information that already has been registered. Thus, the user has no other choice but to separately execute the creation of the color profile after the setting of the paper information has been completed with the medium sensor.

### SUMMARY OF THE INVENTION

The present disclosure allows registration of paper characteristics and a color profile based on an instruction by a single user operation.

A printing system includes an image forming apparatus and an information processing apparatus. The image forming apparatus includes a unit configured to detect a paper characteristic that detects the paper characteristic of paper to be fed, a unit configured to control printing that controls the printing, on the paper to be fed, of a chart in which a color patch is disposed, and a unit configured to perform colorimetry that performs the colorimetry on the color patch disposed in the printed chart. The information processing apparatus includes a unit configured to instruct that instructs, based on an instruction by a user, the image forming apparatus to detect the paper characteristic of the paper to be fed by using the unit configured to detect a paper characteristic of the image forming apparatus, to print the chart in which the color patch is disposed, and to perform the colorimetry on the color patch disposed in the printed chart, a unit configured to receive that receives, from the image forming apparatus, the detected paper characteristic and a result of the colorimetry, and a unit configured to register that creates, based on the result of the colorimetry, a color profile for adjustment of a color to be printed by the image forming apparatus, associates the detected paper characteristic and the color profile with each other, and resisters the paper characteristic and the color profile associated with each other.

Further features of the present disclosure will become apparent from the following description of exemplary embodiments with reference to the attached drawings.

### BRIEF DESCRIPTION OF THE DRAWINGS

FIG. 1 illustrates an example of the configuration of a printing system.

FIG. 2 illustrates an example of a hardware configuration of the printing system.

FIG. 3 is a block diagram illustrating an example of a functional configuration of the printing system.

FIG. 4A illustrates an example of a paper information registration screen.

FIG. 4B illustrates an example of the paper information registration screen.

FIG. 5A illustrates an example of a color profile registration screen.

FIG. 5B illustrates an example of the color profile registration screen.

FIG. 5C illustrates an example of the color profile registration screen.

FIG. 6A illustrates an example of a paper information management.

FIG. 6B illustrates an example of the paper information management.

FIG. 6C illustrates an example of the paper information management.

FIG. 7 is a flowchart illustrating a flow of processing in an information processing apparatus.

FIG. 8A is a flowchart illustrating a flow of processing in an image forming apparatus.

FIG. 8B is a flowchart illustrating a flow of processing in the image forming apparatus.

FIG. 9 illustrates an example of a colorimetric sensor prohibitive screen during creation of a color profile.

FIG. 10A is a flowchart illustrating a flow of processing in the information processing apparatus.

FIG. 10B is a flowchart illustrating a flow of processing in the information processing apparatus.

FIG. 11A is a flowchart illustrating a flow of processing in the image forming apparatus.

FIG. 11B is a flowchart illustrating a flow of processing in the image forming apparatus.

FIG. 12 illustrates an example of a selection screen for a colorimetric sensor usable for colorimetry.

FIG. 13A is a flowchart illustrating a flow of processing in the information processing apparatus

FIG. 13B is a flowchart illustrating a flow of processing in the information processing apparatus.

FIG. 14A is a flowchart illustrating a flow of processing in the image forming apparatus.

FIG. 14B is a flowchart illustrating a flow of processing in the image forming apparatus.

FIG. 15 illustrates an example of a determination result screen for a colorimetric sensor.

FIG. 16A is a flowchart illustrating a flow of processing in the information processing apparatus.

FIG. 16B is a flowchart illustrating a flow of processing in the information processing apparatus.

FIG. 16C is a flowchart illustrating a flow of processing in the information processing apparatus.

FIG. 17A is a flowchart illustrating a flow of processing in the image forming apparatus.

FIG. 17B is a flowchart illustrating a flow of processing in the image forming apparatus.

### DESCRIPTION OF THE EMBODIMENTS

Hereinafter, embodiments will be described with reference to the drawings. None of the following embodiments limit the scope of the claims. Not all the combinations of features described in the embodiments are necessary for solution.

### First Embodiment

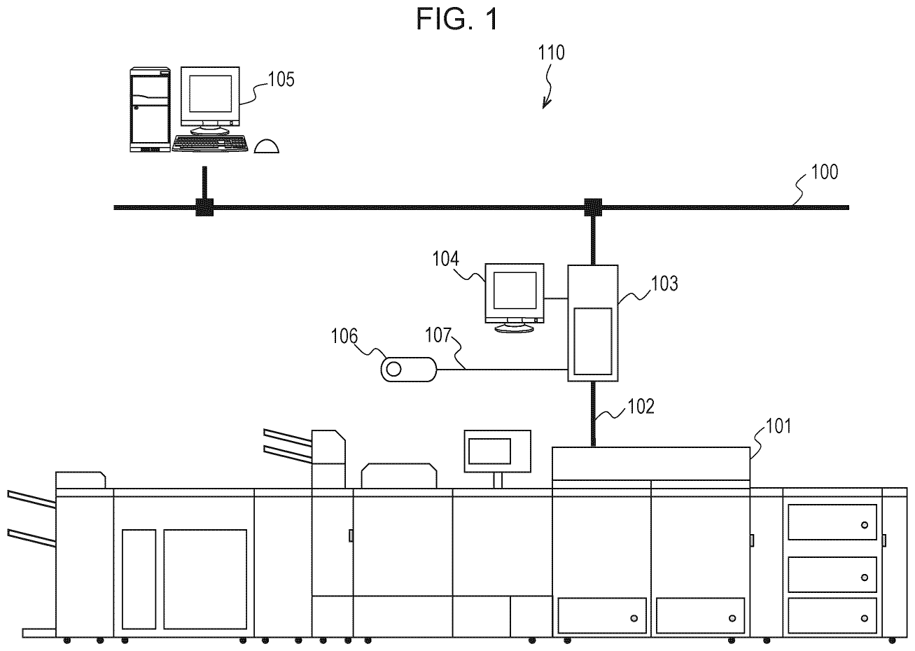

FIG. 1 is a block diagram illustrating an example of the configuration of a printing system 110 according to a first embodiment.

The printing system 110 includes a network 100, an image forming apparatus 101, a network 102, an information processing apparatus 103, a monitor 104, a personal computer (PC) 105, an external colorimetric apparatus 106, and a serial bus 107.

According to the present embodiment, the image forming apparatus 101 and the information processing apparatus 103 are communicably connected to each other via the network 102. Although a single information processing apparatus 103 is provided in the printing system 110 in the example illustrated in FIG. 1, a plurality of information processing apparatuses 103 may be communicably connected to the image forming apparatus 101 via the network 100.

Although the printing system 110 according to the present embodiment exemplifies a case where the image forming apparatus 101 and the information processing apparatus 103 are included, this is not limiting.

The image forming apparatus 101 have a reading function configured to read an image on a sheet and a printing function configured to print an image on a sheet. The image forming apparatus 101 also has post-processing functions configured to bind a plurality of sheets on which images have been printed, align the plurality of sheets, and set destinations of the plurality of sheets into a plurality of trays.

The sheets include various types of paper such as normal paper, cardboard, and coated paper, a film, and the like.

Although the image forming apparatus 101 is described as an example of an image forming apparatus according to the present embodiment, the image forming apparatus may be, for example, a printer or the like that does not have the reading function.

The information processing apparatus 103 is configured to process print job data input to the image forming apparatus 101. Specifically, the information processing apparatus 103 provides the functions of a type of server configured to perform correction, editing, and high-speed raster image processing (RIP) on the print job data input from the PC 105 or the like connected via the network 100 and perform storing, management, and the like on the print job data.

The functions of the information processing apparatus 103 may be realized as a subset of the functions of a main body of the image forming apparatus 101. Furthermore, the information processing apparatus 103 may be accompanied with various types of input/output devices such as, for example, the monitor 104 and the like similar to those included in the PC 105.

The external colorimetric apparatus 106 and the information processing apparatus 103 are connected to each other via the serial bus 107. The external colorimetric apparatus 106 is configured to measure a color and input a measured color value to the information processing apparatus 103. The information processing apparatus 103 executes, for example, adjustment of color accuracy in accordance with the measured color value.

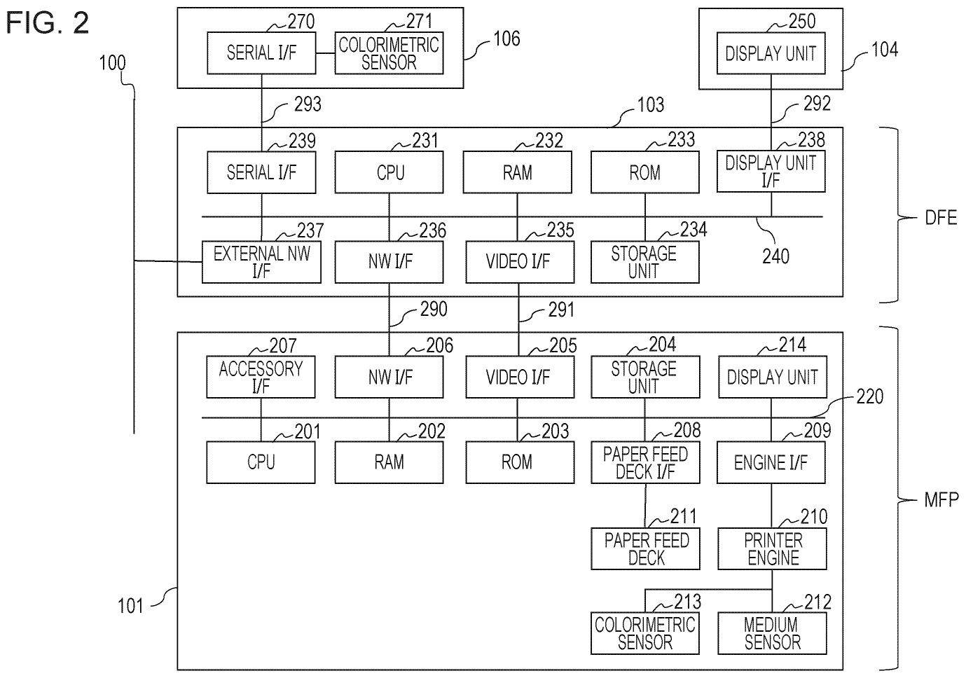

FIG. 2 illustrates an example of a hardware configuration of the printing system 110 according to the first embodiment.

The image forming apparatus 101 is, for example, a multifunction peripheral (MFP). The image forming apparatus 101 includes a central processing unit (CPU) 201, a random-access memory (RAM) 202, a read-only memory (ROM) 203, a storage unit 204, a video interface (I/F) 205, a network (NW) I/F 206, an accessory I/F 207, a paper feed deck I/F 208, an engine I/F 209, and a display unit 214. The image forming apparatus 101 transfers a data signal and a control signal via a bus 220.

The video I/F 205 is connected to a video I/F 235 included in the information processing apparatus 103 via a video cable 291 so as to allow transmission and reception of image data.

The NW I/F 206 is connected to a NW I/F 236 included in the information processing apparatus 103 via a local area network (LAN) cable 290 so as to allow communications of various types of information such as, for example, transmission/reception of a print job.

The accessory I/F 207 allows, for example, a paper discharge apparatus configured to perform a paper discharge process and a post-processing apparatus configured to perform post processing on paper after printing to be connected to and communicate with the image forming apparatus 101.

The paper feed deck I/F 208 can be connected to and communicate with a paper feed deck 211. The paper feed deck 211 allows paper to be loaded therein and is able to continuously feed pieces of the paper at appropriate timing.

The engine I/F 209 can be connected to and communicate with a printer engine 210 configured to control, for example, output of an image and conveyance of paper.

The printer engine 210 is configured to control and operate various sensors such as a medium sensor 212 and a colorimetric sensor 213. Information measured by the medium sensor 212 and a value measured by the colorimetric sensor 213 can be notified to the information processing apparatus 103 via, for example, the NW I/F 206.

The information processing apparatus 103 includes a CPU 231, a RAM 232, a ROM 233, a storage unit 234, the video I/F 235, the NW I/F 236, an external NW I/F 237, a display unit I/F 238, and a serial I/F 239. The information processing apparatus 103 transfers the data signal and the control signal via a bus 240.

The video I/F 235 is connected to the video I/F 205 included in the image forming apparatus 101 via the video cable 291 so as to allow transmission and reception of the image data.

The NW I/F 236 is connected to the NW I/F 206 included in the image forming apparatus 101 via the LAN cable 290 so as to allow communications of various types of information such as, for example, transmission/reception of the print job.

The external NW I/F 237 is connected to the network 100 so as to allow control of communication with, for example, the PC 105.

The display unit I/F 238 is connected to a display unit 250 included in the monitor 104 via a video cable 292 so as to allow output of a screen.

The serial I/F 239 is connected to a serial I/F 270 included in the external colorimetric apparatus 106 via a serial bus 293 so as to allow communication.

The external colorimetric apparatus 106 includes a colorimetric sensor 271 and can notify, via the serial I/F 270, the information processing apparatus 103 of a color value measured by the colorimetric sensor 271.

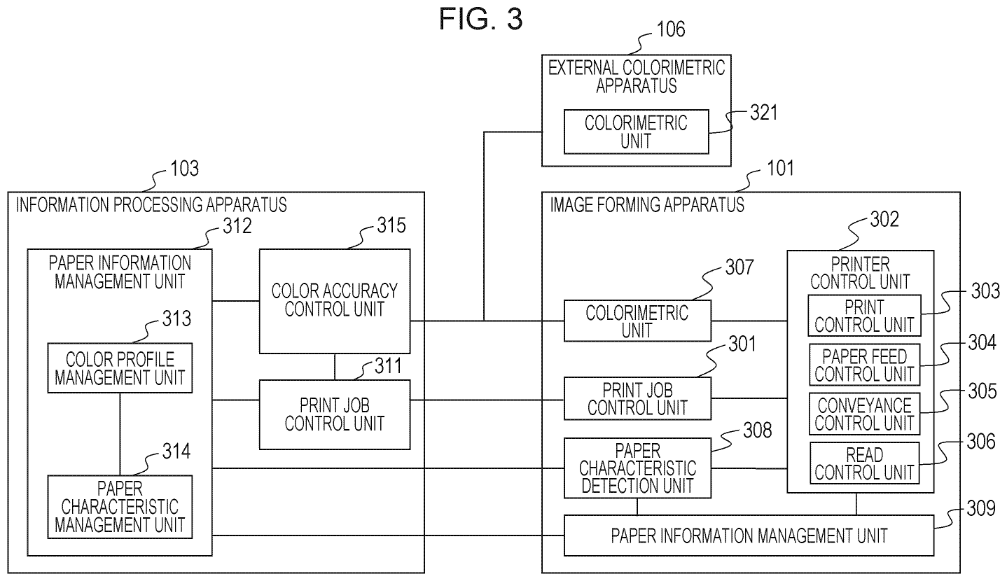

FIG. 3 is a block diagram illustrating an example of a functional configuration of the printing system 110 according to the present embodiment.

The image forming apparatus 101 includes a print job control unit 301, a printer control unit 302, a colorimetric unit 307, a paper characteristic detection unit 308, and a paper information management unit 309.

The print job control unit 301 is executed in accordance with a program stored in the ROM 203 included in the image forming apparatus 101. The print job control unit 301 is configured to receive the print job from, for example, a print job control unit 311 of the information processing apparatus 103, interpret the print job, and issue a print control instruction based on the content of the print job to the printer control unit 302.

The printer control unit 302 includes a print control unit 303, a paper feed control unit 304, a conveyance control unit 305, and a read control unit 306. These units of the printer control unit 302 are each executed in accordance with the program stored in the ROM 203 included in the image forming apparatus 101. The printer control unit 302 operates also in accordance with the instruction of the print job control unit 301.

The print control unit 303 is configured to process the image data received from the print job control unit 301 and control print operation.

The paper feed control unit 304 is configured to, for example, obtain paper information of the paper feed unit from the paper information management unit 309, select a paper feed unit based on specification in the print job, and control the paper feeding of a sheet from the selected paper feed unit to the conveying path.

The conveyance control unit 305 is configured to control feeding of a sheet in the conveying path based on the selected paper information.

The read control unit 306 is configured to control reading performed by the various sensors included in the image forming apparatus 101. For example, the colorimetric unit 307 is configured to perform colorimetry operation with the colorimetric sensor 213 in accordance with an instruction from the read control unit 306 and notify of the colorimetric value a color accuracy control unit 315 included in the information processing apparatus 103.

The paper characteristic detection unit 308 is configured to execute paper characteristic detecting operation with the medium sensor 212 in accordance with an instruction from the read control unit 306 and notify of a result of the detection the paper information management unit 309 included in the image forming apparatus 101 or a paper information management unit 312 included in the information processing apparatus 103.

The paper information management unit 309 is executed in accordance with the program stored in the ROM 203 included in the image forming apparatus 101. The paper information management unit 309 is configured to manage paper information handled by the image forming apparatus 101. For example, the paper information management unit 309 manages information on paper fed to the paper feed deck 211 included in the image forming apparatus 101. This paper information may be created in accordance with an instruction from the paper information management unit 312 included in the information processing apparatus 103 or may be created based on the detection result of the paper characteristic detection unit 308.

The information processing apparatus 103 includes the print job control unit 311, the paper information management unit 312, and the color accuracy control unit 315.

The print job control unit 311 is executed in accordance with a program stored in the ROM 233 included in the information processing apparatus 103. The print job control unit 311 is configured to control, for example, generation of the print job and input of the print job to the print job control unit 301 of the image forming apparatus 101.

The paper information management unit 312 is executed in accordance with the program stored in the ROM 233 included in the information processing apparatus 103. The paper information management unit 312 includes a color profile management unit 313 and a paper characteristic management unit 314 and is configured to manage the paper characteristics controlled by the image forming apparatus 101.

The color profile management unit 313 is configured to manage color profiles corresponding to pieces of paper information managed by the paper characteristic management unit 314.

The color accuracy control unit 315 is executed in accordance with the program stored in the ROM 233 included in the information processing apparatus 103. The color accuracy control unit 315 is configured to, for example, instruct the print job control unit 311 to create a chart job for color profile creation and to receive notification of the colorimetry result from the colorimetric unit 307 included in the image forming apparatus 101.

The notification of the colorimetry result of the chart job may be received from a colorimetric unit 321 included in the external colorimetric apparatus 106 instead of the colorimetric unit 307 included in the image forming apparatus 101. The color accuracy control unit 315 can create a new color profile from a received colorimetric value and register the color profile in the color profile management unit 313 included in the paper information management unit 312.

The external colorimetric apparatus 106 includes the colorimetric unit 321. The external colorimetric apparatus 106 is configured to measure, with the colorimetric unit 321, due to operation by a user, the color of a chart in which a color patch is disposed output from the image forming apparatus 101 and notify of the colorimetry result the color accuracy control unit 315 included in the information processing apparatus 103.

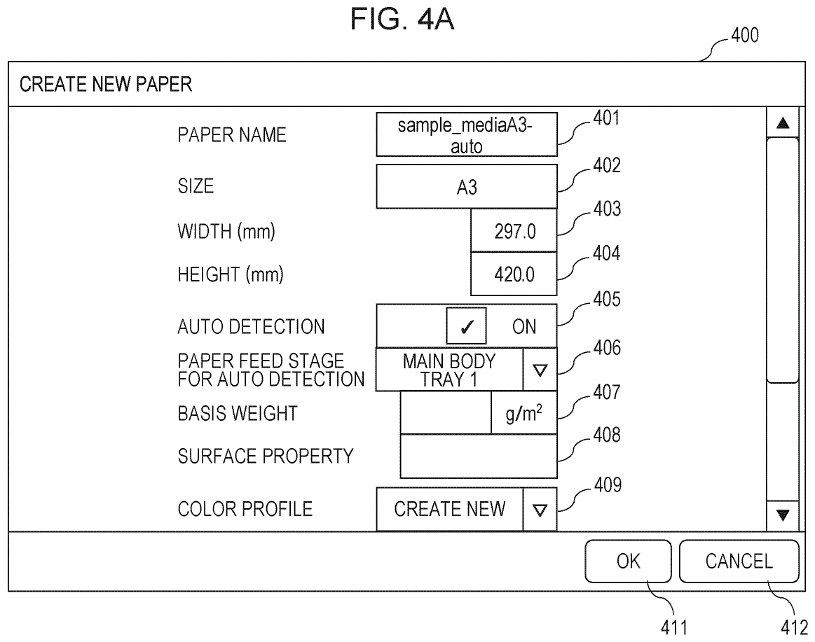

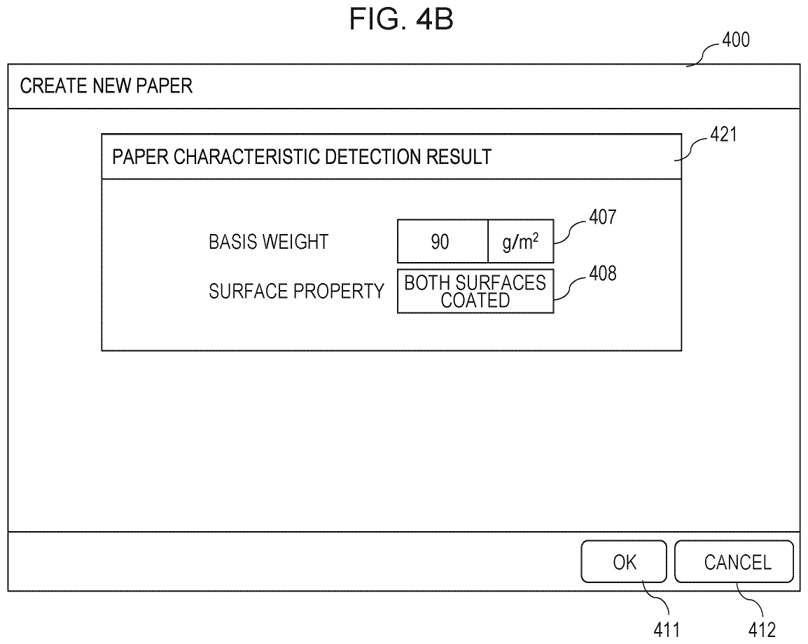

FIGS. 4A and 4B illustrate examples of a paper information registration screen 400 to be displayed in the display unit 250 of the monitor 104 connected to the information processing apparatus 103. The paper information registration screen 400 may be displayed in the display unit 214 included in the image forming apparatus 101.

FIG. 4A illustrates the paper information registration screen 400 for input of setting values of the paper information. The paper information registration screen 400 includes a paper name 401, a paper size 402, a paper width 403, a paper height 404, an auto paper characteristic detection switch 405, a paper feed stage for auto detection 406, a basis weight 407, a surface property 408, a color profile 409, and the like.

The paper characteristic information including the paper name 401, the paper size 402, the paper width 403, the paper height 404, the basis weight 407, and the surface property 408 having been input in the paper information registration screen 400 is determined by pushing down an OK button 411. The paper characteristic information is registered, as the paper information, in the paper characteristic management unit 314 included in the information processing apparatus 103. Alternatively, the paper characteristic information may be registered in the paper information management unit 309 included in the image forming apparatus.

The auto paper characteristic detection switch 405 allows, when detecting the paper characteristic with the medium sensor 212 included in the image forming apparatus 101, switching of whether to automatically register the paper characteristic based on the detection result.

According to the present embodiment, the paper characteristic information able to be detected by the medium sensor 212 is the basis weight 407 and the surface property 408. When the auto paper characteristic detection switch 405 is ON, input of the basis weight 407 or the surface property 408 being paper characteristic information detectable by the medium sensor 212 is not accepted. Furthermore, when the auto paper characteristic detection switch 405 is ON, the paper feed deck 211 is selected which is included in the image forming apparatus 101 assigned with paper that is wanted to be registered at the paper feed stage for auto detection 406.

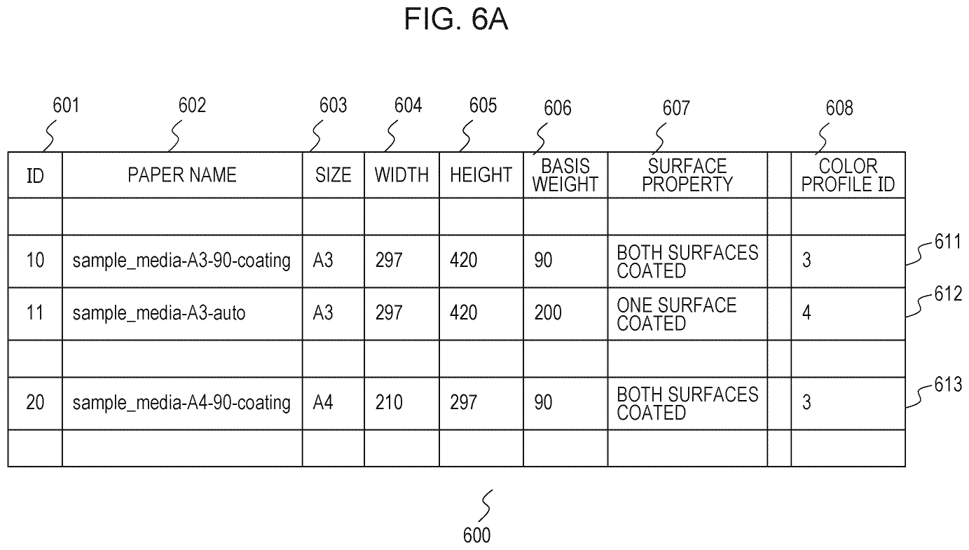

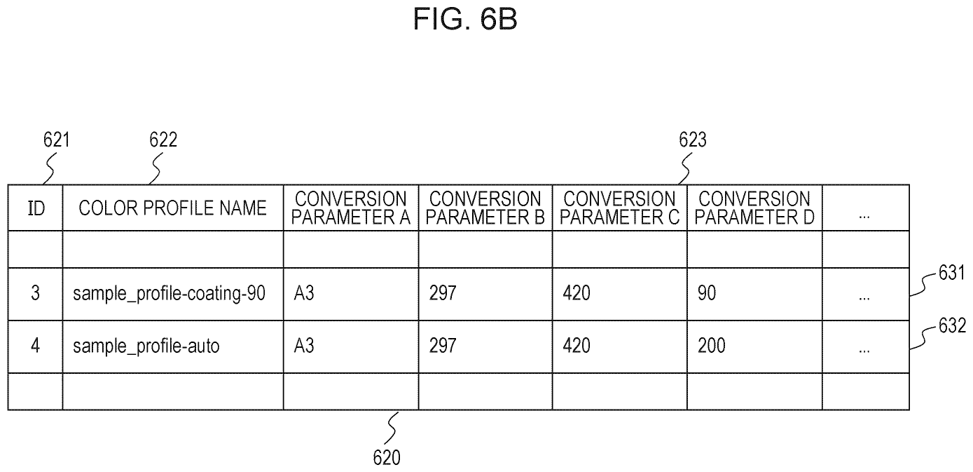

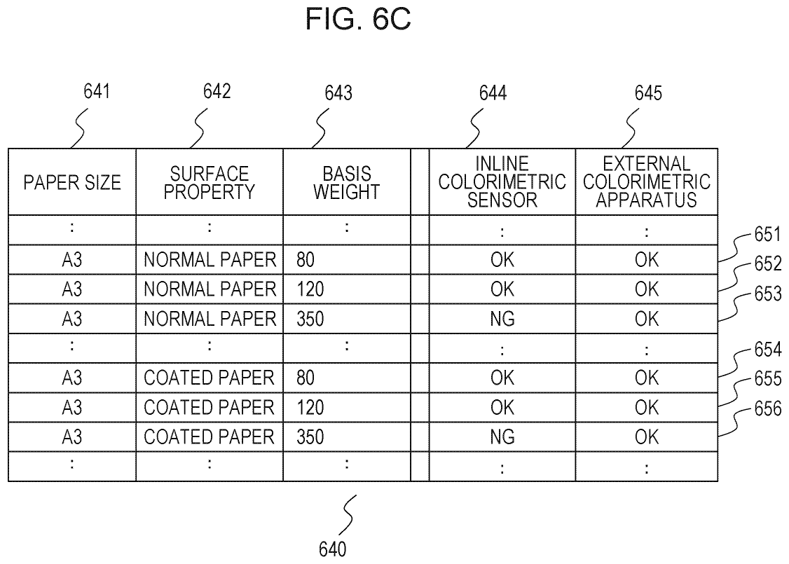

A color profile associated with the paper characteristics registered in the paper information registration screen 400 is specified in the color profile 409. An existing color profile can be specified in the color profile 409. This existing color profile, which has already been managed by the color profile management unit 313, is stored in color profile information 620 illustrated in FIG. 6B stored in the storage unit 234 included in the information processing apparatus 103.

When the OK button 411 is pushed down, the paper information to be registered is determined. When the auto paper characteristic detection switch 405 is OFF, the content of the paper information is held in paper characteristic information 600 illustrated in FIG. 6A stored in the storage unit 234 included in the information processing apparatus 103 managed, in accordance with input values, by the paper characteristic management unit 314 included in the information processing apparatus 103.

When the auto paper characteristic detection switch 405 is ON, neither the basis weight 407 nor the surface property 408 is input. Thus, the print job control unit 311 included in the information processing apparatus 103 is instructed to create a paper characteristic detection job. The paper characteristics are detected by the medium sensor 212 included in the image forming apparatus 101, and the paper information is determined based on the paper characteristic information received from the paper characteristic detection unit 308.

FIG. 4B illustrates a paper characteristic detection result screen 421 when the paper characteristics are determined while the auto paper characteristic detection switch 405 is ON. The basis weight 407 and the surface property 408 being the paper characteristic information received from the paper characteristic detection unit 308 of the image forming apparatus 101 are displayed.

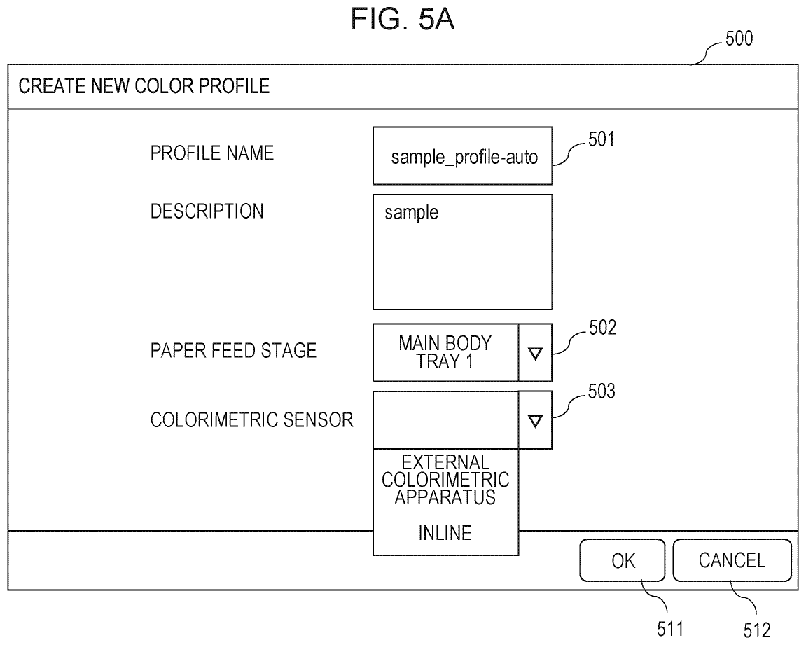

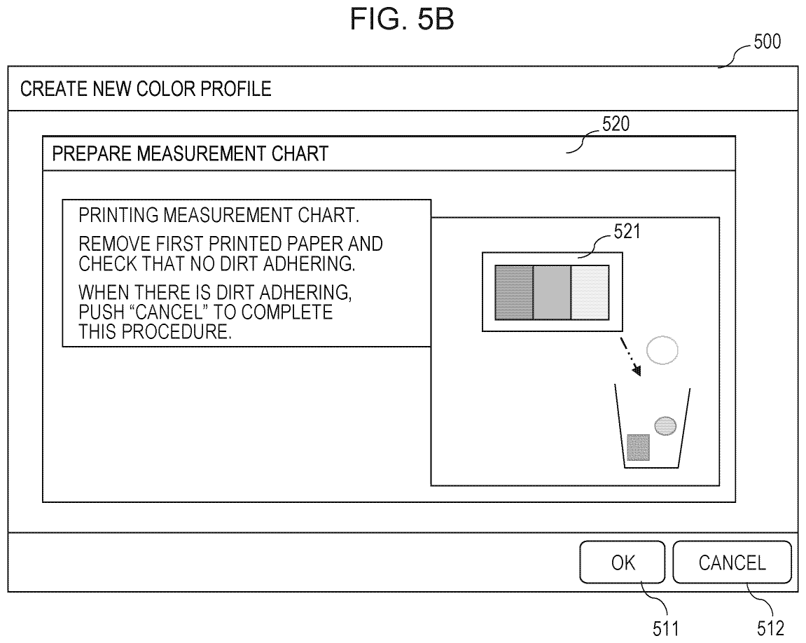

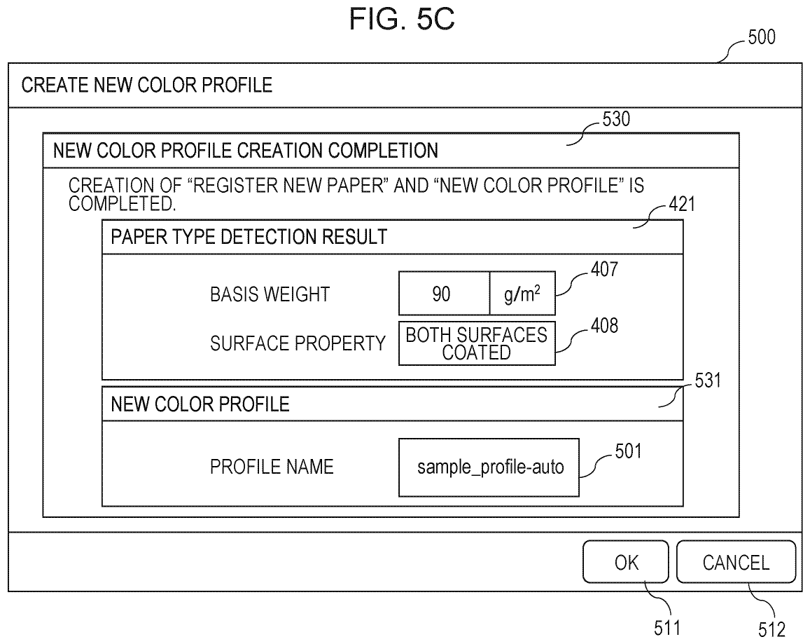

However, when a create new is selected in the color profile 409 of the paper information registration screen 400 illustrated in FIG. 4A, even in the case where the auto paper characteristic detection switch 405 is ON, the paper characteristic detection job is not created, and the processing transitions to a create new color profile screen 500 illustrated in FIG. 5A.

FIGS. 5A to 5C illustrate examples of the create new color profile screen 500 to be displayed in the display unit 250 of the monitor 104 connected to the information processing apparatus 103. Alternatively, the create new color profile screen 500 may be displayed in the display unit 214 included in the image forming apparatus 101.

FIG. 5A illustrates the create new color profile screen 500 for inputting setting values to create a new color profile. The create new color profile screen 500 includes a color profile name 501, a paper feed stage 502, a colorimetric sensor 503, and the like. Transition to the create new color profile screen 500 can also be performed when the create new is designated in the color profile 409 included in the paper information registration screen 400 illustrated in FIG. 4A.

The paper feed stage 502 specifies the paper feed deck 211 included in the image forming apparatus 101 to which paper of a color profile creation object is assigned.

The colorimetric sensor 503 is to select a colorimetric unit able to measure the color of a color chart output from the image forming apparatus 101. FIG. 5A illustrates an example of a case where the external colorimetric apparatus 106 is usable, and further, the image forming apparatus 101 includes the colorimetric sensor 213.

When an OK button 511 is pushed down, the processing transitions to a new color profile creation process flow and transitions to a measurement chart preparation screen 520 illustrated in FIG. 5B.

In a processing flow of a measurement chart preparation, the color accuracy control unit 315 included in the information processing apparatus 103 instructs the print job control unit 311 to print a measurement preparation chart 521. The measurement preparation chart 521 is used for pre-processing of a color accuracy adjustment process. The objects of the measurement preparation chart 521 are a warming-up operation for improving application of toner to the paper, checking whether dirt adhering to an output chart, and the like. An objective paper of the new color profile creation is used for the measurement preparation chart 521.

As indicated in the measurement chart preparation screen 520, the measurement preparation chart 521 is abandoned by the user after the dirt has been confirmed. The user checks the measurement preparation chart 521. When the presence of dirt is confirmed, the user pushes down a cancel button 512 to exit the new color profile creation process flow. When it is confirmed that no dirt is present, the user pushes down the OK button 511 to continue the new color profile creation process flow.

When the new color profile creation process flow is continued, the color accuracy control unit 315 included in the information processing apparatus 103 instructs the print job control unit 311 to create a measurement preparation chart job which can be subjected to colorimetry by the colorimetric sensor designated in the colorimetric sensor 503.

When the colorimetric sensor 213 included in the image forming apparatus 101 is designated, the color accuracy control unit 315 included in the information processing apparatus 103 receives the colorimetric value from the colorimetric unit 307 included in the image forming apparatus 101.

When the colorimetric sensor 271 included in the external colorimetric apparatus 106 is designated, the color accuracy control unit 315 included in the information processing apparatus 103 receives the colorimetric value from the colorimetric unit 321 included in the external colorimetric apparatus 106.

Upon reception of the colorimetric value, the color accuracy control unit 315 included in the information processing apparatus 103 executes a new color profile creation process in accordance with the colorimetric value, and the processing transitions to a new color profile creation completion screen 530 illustrated in FIG. 5C.

The new color profile creation completion screen 530 includes a new color profile screen 531 configured to display new color profile information which has already been created. Furthermore, when the auto paper characteristic detection switch 405 is ON in the paper information registration screen 400 illustrated in FIG. 4A, and the processing transitions to the new color profile creation process flow, the new color profile creation completion screen 530 includes the paper characteristic detection result screen 421.

When the user pushes down the OK button 511, the paper information is held in the paper characteristic information 600 illustrated in FIG. 6A stored in the storage unit 234 included in the information processing apparatus 103 managed by the paper characteristic management unit 314 included in the information processing apparatus 103.

Furthermore, the new color profile is held in the color profile information 620 illustrated in FIG. 6B stored in the storage unit 234 included in the information processing apparatus 103 managed by the color profile management unit 313.

Then, the new color profile creation process flow is completed. When the user pushes down the cancel button 512, the paper information and the new color profile are abandoned, and the new color profile creation process flow is completed.

FIG. 6A illustrates an example of the paper characteristic information 600 stored in the storage unit 234 included in the information processing apparatus 103. The paper characteristic information 600 is managed by the paper characteristic management unit 314 included in the paper information management unit 312 included in the information processing apparatus 103. Alternatively, the paper characteristic information 600 may be stored in the storage unit 204 included in the image forming apparatus 101 and managed by the paper information management unit 309.

The paper characteristic information 600 includes a paper ID 601, a paper name 602, a paper size 603, a paper width 604, a paper height 605, a basis weight 606, and a surface property 607. The paper characteristic information 600 is held in the paper characteristic management unit 314 included in the information processing apparatus 103.

Furthermore, the paper characteristic information 600 has a color profile ID 608 associated therewith. In the color profile ID 608, which of the color profiles held in the color profile information 620 illustrated in FIG. 6B stored in the storage unit 234 included in the information processing apparatus 103 is assigned is indicated by a color profile ID 621.

The paper ID 601 is an internal ID with which a piece of the paper information can be uniquely determined. The paper name 602, the paper size 603, the paper width 604, and the paper height 605 hold the values respectively input into the paper name 401, the paper size 402, the paper width 403, and the paper height 404 included in the paper information registration screen 400 illustrated in FIG. 4A.

When the auto paper characteristic detection switch 405 included in the paper information registration screen 400 illustrated in FIG. 4A is OFF, the basis weight 606 and the surface property 607 hold the values respectively input into the basis weight 407 and the surface property 408 included in the paper information registration screen 400.

When the auto paper characteristic detection switch 405 included in the paper information registration screen 400 is ON, the basis weight 606 and the surface property 607 are detected by the paper characteristic detection unit 308 included in the image forming apparatus 101. Then, the values of the basis weight 606 and the surface property 607 are held based on the paper characteristic information notified to the paper information management unit 312 included in the information processing apparatus 103.

The color profile ID 608 indicates the assignment, to the object paper ID 601, of the ID of the color profile managed by the color profile management unit 313 included in the information processing apparatus 103.

FIG. 6B illustrates an example of the color profile information 620 stored in the storage unit 234 included in the information processing apparatus 103. The color profile information 620 is managed by the color profile management unit 313 included in the paper information management unit 312 included in the information processing apparatus 103. Alternatively, the color profile information 620 may be stored in the storage unit 204 included in the image forming apparatus 101 and managed by the paper information management unit 309.

The color profile information 620 includes the color profile ID 621, a color profile name 622, and a plurality of conversion parameters 623.

The color profile ID 621 is an internal ID with which a piece of the color profile information can be uniquely determined.

The value input into the color profile name 501 included in the create new color profile screen 500 illustrated in FIG. 5A is held in the color profile name 622.

The conversion parameters 623 are created by the color accuracy control unit 315 in accordance with the colorimetric value received by the new color profile creation process.

FIG. 6C illustrates an example of a colorimetric sensor ability table 640 stored in the storage unit 234 included in the information processing apparatus 103. The colorimetric sensor ability table 640 is managed by the color profile management unit 313 included in the paper information management unit 312 included in the information processing apparatus 103. Alternatively, the colorimetric sensor ability table 640 may be stored in the storage unit 204 included in the image forming apparatus 101 and managed by the paper information management unit 309.

The colorimetric sensor ability table 640 includes a paper size 641, a paper surface property 642, a paper basis weight 643, an inline colorimetric sensor ability 644, and an external colorimetric apparatus ability 645.

The inline colorimetric sensor ability 644 is information indicating whether the paper characteristics can be subjected to colorimetry with the colorimetric sensor 213 included in the image forming apparatus 101. In the example illustrated in FIG. 6C, the paper characteristics indicated in paper characteristics 651, 652, 654, and 655 can be subjected to colorimetry.

In contrast, colorimetry cannot be performed with the paper characteristics indicated in the paper characteristics 653 or 656.

The external colorimetric apparatus ability 645 is information indicating whether the paper characteristics can be subjected to colorimetry by the colorimetric sensor 271 included in the external colorimetric apparatus 106. In the example illustrated in FIG. 6C, all the paper characteristics 652 to 656 can be subjected to colorimetry.

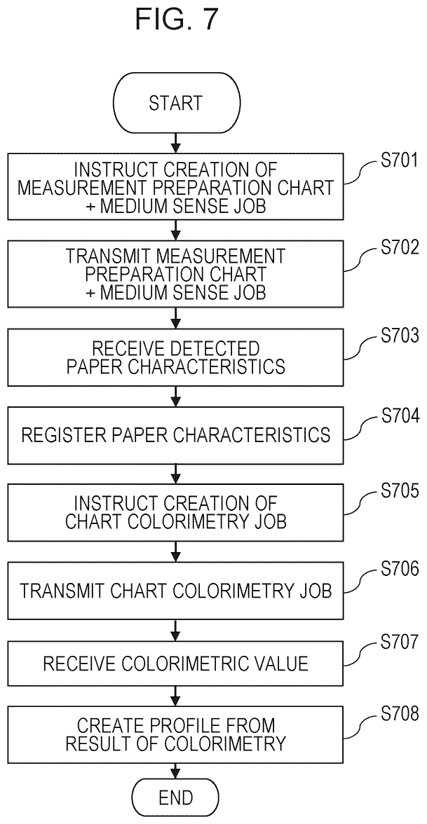

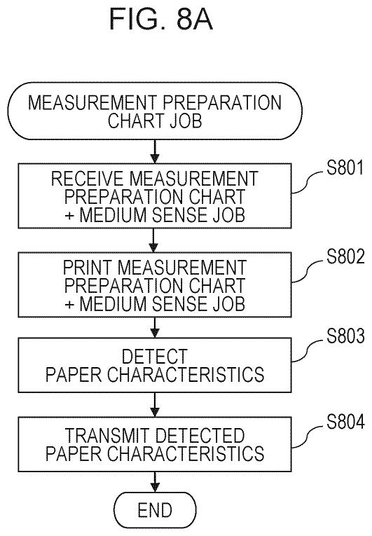

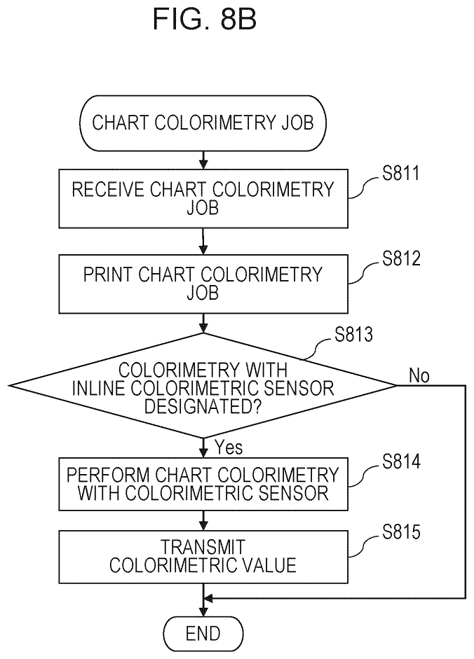

FIG. 7 is a flowchart illustrating a processing method in the information processing apparatus 103 for executing paper characteristic detection and paper type registration in an output profile creation flow. FIGS. 8A and 8B are flowcharts illustrating the processing method in the image forming apparatus 101.

Processing in the information processing apparatus 103 illustrated in FIG. 7 is realized by execution in accordance with the program stored in the ROM 233 included in the information processing apparatus 103. Processing in the image forming apparatus 101 illustrated in FIGS. 8A and 8B is realized by execution in accordance with the program stored in the ROM 203 included in the image forming apparatus 101.

When the OK button 511 is pushed down in the create new color profile screen 500 illustrated in FIG. 5A, a flow illustrated in FIG. 7 is started.

In step S701, the color accuracy control unit 315 included in the information processing apparatus 103 instructs the print job control unit 311 to create the measurement preparation chart job. At this time, the color accuracy control unit 315 imparts, to the measurement preparation chart job, a medium sense setting for detecting the paper characteristics.

In step S702, the print job control unit 311 included in the information processing apparatus 103 transmits the measurement preparation chart job to which the medium sense setting is imparted to the print job control unit 301 included in the image forming apparatus 101.

In step S703, the print job control unit 311 included in the information processing apparatus 103 waits for reception of the paper characteristic information from the paper characteristic detection unit 308 included in the image forming apparatus 101.

In step S801 illustrated in FIG. 8A, the print job control unit 301 included in the image forming apparatus 101 receives the measurement preparation chart job transmitted in step S702 from the print job control unit 311 included in the information processing apparatus 103.

In step S802, the print job control unit 301 interprets the received measurement preparation chart job and instructs the printer control unit 302 to print the measurement preparation chart job.

In step S803, the read control unit 306 included in the printer control unit 302 instructs the paper characteristic detection unit 308 to detect the paper characteristics because of the imparting, to the measurement preparation chart job, of the medium sense setting for detecting the paper characteristics. The paper characteristic detection unit 308 detects the paper characteristics of the paper to be fed with the medium sensor 212. The paper characteristic detection unit 308 conveys the paper onto the conveying path and detects the paper characteristics of the paper on the feeding path with the medium sensor 212.

In step S804, the paper characteristic detection unit 308 transmits the detected paper characteristic information to the paper information management unit 312 included in the information processing apparatus 103 and completes the processing illustrated in FIG. 8A.

In step S703 illustrated in FIG. 7, the paper information management unit 312 included in the information processing apparatus 103 functions as a receiving unit and receives the paper characteristic information transmitted in step S804 from the paper characteristic detection unit 308 included in the image forming apparatus 101.

In step S704, the paper information management unit 312 registers the received paper characteristic information in the paper characteristic management unit 314.

In step S705, the color accuracy control unit 315 instructs the print job control unit 311 to create a chart colorimetry job. At this time, the color accuracy control unit 315 imparts, to the chart colorimetry job, the colorimetric sensor selected in the colorimetric sensor 503 included in the create new color profile screen 500 illustrated in FIG. 5A as a colorimetric sensor setting.

In step S706, the print job control unit 311 transmits the chart colorimetry job to which the colorimetric sensor setting is imparted to the print job control unit 301 included in the image forming apparatus 101. The print job control unit 311 transmits the chart colorimetry job to the external colorimetric apparatus 106 when the colorimetric sensor 271 is selected as the colorimetric sensor 503 illustrated in FIG. 5A.

In step S707, the print job control unit 311 waits for the reception of the colorimetric value from the colorimetric unit 307 included in the image forming apparatus 101 or the colorimetric unit 321 included in the external colorimetric apparatus 106.

In step S811 illustrated in FIG. 8B, the print job control unit 301 included in the image forming apparatus 101 receives the chart colorimetry job transmitted in step S706 from the print job control unit 311 included in the information processing apparatus 103.

In step S812, the print job control unit 301 interprets the received chart colorimetry job and instructs the printer control unit 302 to print the chart colorimetry job. The printer control unit 302 is a print control unit configured to control printing, on the paper to be fed, of the chart in which the color patch is disposed.

In step S813, the printer control unit 302 determines, based on the colorimetric sensor setting, whether the chart colorimetry job designates the colorimetric sensor 213 included in the image forming apparatus 101. When the colorimetric sensor 213 included in the image forming apparatus 101 is designated (Yes in S813), the processing proceeds to step S814. When the colorimetric sensor 213 included in the image forming apparatus 101 is not designated (No in S813), the processing illustrated in FIG. 8B is completed.

In step S814, the read control unit 306 instructs the colorimetric unit 307 to perform colorimetry on the chart colorimetry job, and the colorimetry of the chart is executed with the colorimetric sensor 213. The colorimetric sensor 213 performs colorimetry on the color patch disposed in the chart having been printed in step S812.

In step S815, the colorimetric unit 307 transmits the colorimetric value as a result of the colorimetry to the color accuracy control unit 315 included in the information processing apparatus 103.

In step S707 illustrated in FIG. 7, the color accuracy control unit 315 included in the information processing apparatus 103 receives the colorimetric value from the colorimetric unit 307 or 321.

In the first case, the colorimetric sensor 213 (inline) included in the image forming apparatus 101 is designated in the colorimetric sensor setting designated in the colorimetric sensor 503 of the create new color profile screen 500 illustrated in FIG. 5A. In this case, in step S707, the color accuracy control unit 315 receives the colorimetric value obtained by performing colorimetry on the chart with the colorimetric sensor 213 of the colorimetric unit 307 included in the image forming apparatus 101.

In the next case, the colorimetric sensor 271 included in the external colorimetric apparatus 106 is designated in the colorimetric sensor setting designated in the colorimetric sensor 503 of the create new color profile screen 500 illustrated in FIG. 5A. In this case, in step S707, the color accuracy control unit 315 receives the colorimetric value obtained by performing colorimetry on the chart with the colorimetric sensor 271 of the colorimetric unit 321 included in the external colorimetric apparatus 106.

In step S708, the color accuracy control unit 315 creates the new color profile based on the received colorimetric value in step S707 and registers the color profile in the color profile management unit 313 included in the paper information management unit 312.

The color accuracy control unit 315 functions as a registration unit. The color accuracy control unit 315 creates, as illustrated in FIGS. 6A and 6B, the color profile based on the colorimetric value for adjustment of the color to be printed by the image forming apparatus 101, associates the paper characteristics in step S703 and the color profile with each other, and resisters the paper characteristics and the color profile associated with each other.

According to the present embodiment having been described, the printing system 110 can execute auto paper information registration in an auto color profile creation process. Thus, the printing system 110 can register the paper information in step S704 and the color profile in step S708 in a single step.

Referring to FIG. 7, the print job control unit 311 transmits the measurement preparation chart job in step S702 and the chart colorimetry job in step S706 to the image forming apparatus 101 based on an instruction by a single user operation.

The above-described single user operation is an operation of pushing down the OK button 511 in the create new color profile screen 500 illustrated in FIG. 5A to issue an instruction including selection of the colorimetric sensor 503 illustrated in FIG. 5A.

The selection of the colorimetric sensor 503 illustrated in FIG. 5A is selection of either the colorimetric sensor 213 of the image forming apparatus 101 or the colorimetric sensor 271 of the external colorimetric apparatus 106.

The measurement preparation chart job in step S702 is a job provided for the instruction of detection of the paper characteristics of the paper to be fed by the paper characteristic detection unit 308 of the image forming apparatus 101. The chart colorimetry job in step S706 is a job provided for control of printing of the chart in which the color patch is disposed in the paper to be fed performed by the print control unit 303 of the image forming apparatus 101 and for the instruction of colorimetry on the color patch disposed in the printed chart performed by the colorimetric sensor 213 of the image forming apparatus 101.

According to the present embodiment, registration of the paper characteristic information can be executed in the auto color profile creation process. Thus, the paper characteristic information and the color profile can be registered in a single step. This improves convenience of the user.

### Second Embodiment

According to the first embodiment, the embodiment for registering the paper information and the color profile in a single step has been described. Meanwhile, a subset of paper that can be subjected to colorimetry with the colorimetric sensor 213 included in the image forming apparatus 101 is unable to be subjected to colorimetry depending on the paper characteristics due to influence of an internal mechanism of devices. According to the first embodiment, the paper characteristics are determined after the new color profile creation flow has started. Thus, whether the colorimetry can be performed with the colorimetric sensor 213 included in the image forming apparatus 101 is unable to be determined before the start of the new color profile creation flow.

According to a second embodiment, a configuration for determining whether the colorimetry can be performed with the colorimetric sensor 213 included in the image forming apparatus 101 before the chart colorimetry job is submitted is described.

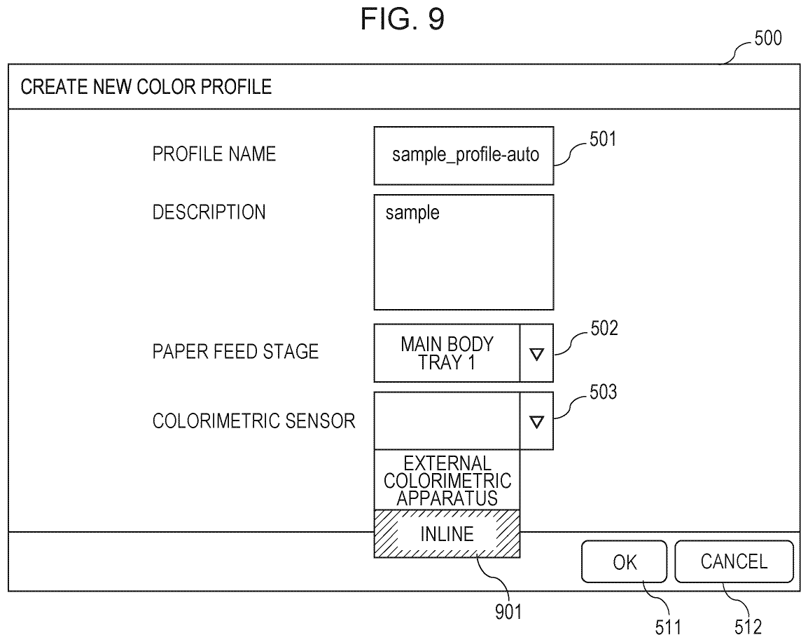

FIG. 9 illustrates an example in the create new color profile screen 500 in which the paper characteristics of an object of the new color profile creation cannot be subjected to the colorimetry with the colorimetric sensor 213 (inline) included in the image forming apparatus 101.

According to the second embodiment, the paper characteristics are determined when the processing transitions to the create new color profile screen 500 in the new color profile creation. Thus, whether the paper characteristics can be subjected to the colorimetry with the colorimetric sensors 213 and 217 can be determined in accordance with the paper characteristics.

When the paper characteristics of the object of the new color profile creation cannot be subjected to the colorimetry with the colorimetric sensor 213 included in the image forming apparatus 101, the colorimetric sensor 213 cannot be designated as the colorimetric sensor 503 illustrated in FIG. 9. Thus, for example, the colorimetric sensor 213 is grayed out as a sensor unusable for colorimetry 901 so as not to be designated. In the present embodiment, a configuration to solve this problem is described.

Next, when the paper characteristic detection and the paper type registration are executed in the output profile creation flow, a flowchart for determining whether the colorimetry can be performed with the colorimetric sensor 213 included in the image forming apparatus 101 before the chart colorimetry job is submitted is described.

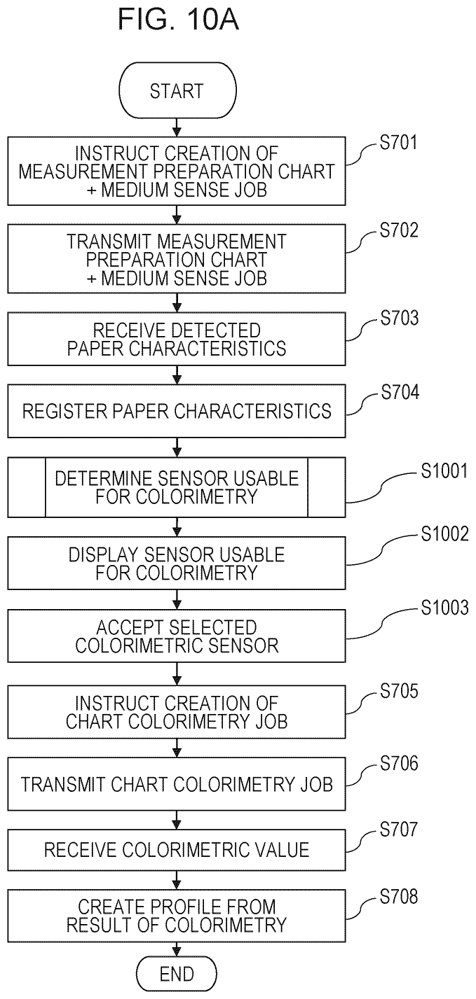

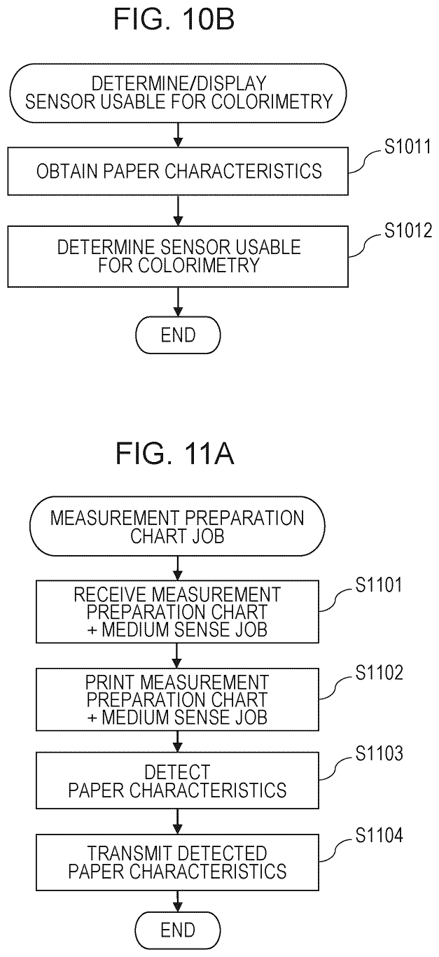

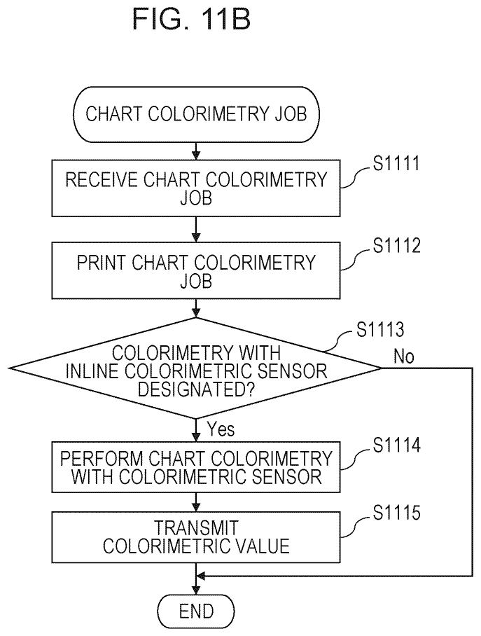

FIGS. 10A and 10B are flowcharts illustrating a processing method in the information processing apparatus 103. FIGS. 11A and 11B are flowcharts illustrating the processing method in the image forming apparatus 101.

Processing in the information processing apparatus 103 illustrated in FIGS. 10A and 10B is realized by execution in accordance with the program stored in the ROM 233 included in the information processing apparatus 103.

Processing in the image forming apparatus 101 illustrated in FIGS. 11A and 11B is realized by execution in accordance with the program stored in the ROM 203 included in the image forming apparatus 101.

When the OK button 511 is pushed down in the create new color profile screen 500 illustrated in FIG. 5A, a flow illustrated in FIG. 10A is started.

In step S701, the color accuracy control unit 315 included in the information processing apparatus 103 instructs the print job control unit 311 to create the measurement preparation chart job. At this time, the color accuracy control unit 315 imparts, to the measurement preparation chart job, the medium sense setting for detecting the paper characteristics.

In step S702, the print job control unit 311 included in the information processing apparatus 103 transmits the measurement preparation chart job to which the medium sense setting is imparted to the print job control unit 301 included in the image forming apparatus 101.

In step S703, the print job control unit 311 included in the information processing apparatus 103 waits for reception of the paper characteristic information from the paper characteristic detection unit 308 included in the image forming apparatus 101.

In step S1101 illustrated in FIG. 11A, the print job control unit 301 included in the image forming apparatus 101 receives the measurement preparation chart job transmitted in step S702 from the print job control unit 311 included in the information processing apparatus 103.

In step S1102, the print job control unit 301 interprets the received measurement preparation chart job and instructs the printer control unit 302 to print the measurement preparation chart job.

In step S1103, the read control unit 306 included in the printer control unit 302 instructs the paper characteristic detection unit 308 to detect the paper characteristics because of the imparting, to the measurement preparation chart job, of the medium sense setting for detecting the paper characteristics. The paper characteristic detection unit 308 detects the paper characteristics of the paper to be fed with the medium sensor 212.

In step S1104, the paper characteristic detection unit 308 transmits the detected paper characteristic information to the paper information management unit 312 included in the information processing apparatus 103 and completes the processing illustrated in FIG. 11A.

In step S703 illustrated in FIG. 10A, the paper information management unit 312 included in the information processing apparatus 103 receives the paper characteristic information transmitted in step S1104 from the paper characteristic detection unit 308 included in the image forming apparatus 101.

In step S704, the paper information management unit 312 registers the received paper characteristic information in the paper characteristic management unit 314.

In step S1001, the color accuracy control unit 315 determines a sensor usable for colorimetry with respect to the colorimetric sensors 213 and 271 in accordance with the paper characteristic information registered in step S704.

FIG. 10B is the flowchart illustrating the details of step S1001 illustrated in FIG. 10A. In step S1011, the color accuracy control unit 315 included in the information processing apparatus 103 obtains the paper characteristic information of the object of the new color profile creation from the paper characteristic management unit 314.

In step S1012, the color accuracy control unit 315 determines a colorimetric sensor usable for colorimetry with respect to the colorimetric sensors 213 and 271 in accordance with the colorimetric sensor ability table 640 illustrated in FIG. 6C and the paper characteristic information having been obtained.

That is, the color accuracy control unit 315 functions as a determination unit, and each of the colorimetric sensor 213 of the image forming apparatus 101 and the colorimetric sensor 271 of the external colorimetric apparatus 106 determines whether colorimetry can be performed for the obtained paper characteristic information.

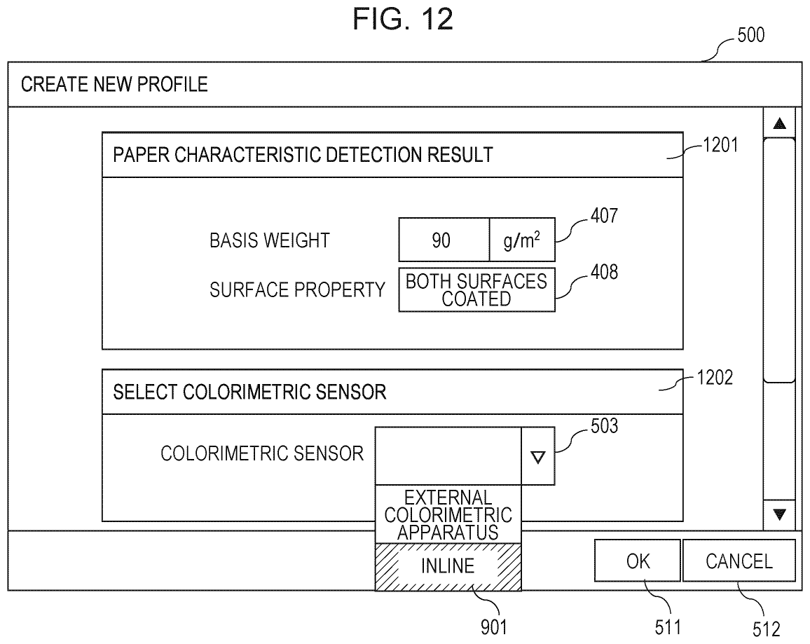

In step S1002 illustrated in FIG. 10A, the color accuracy control unit 315 displays the create new color profile screen 500 illustrated in FIG. 12. The create new color profile screen 500 includes a paper characteristic detection result screen 1201. The color accuracy control unit 315 displays the paper characteristic information received in step S703 in the paper characteristic detection result screen 1201 as the basis weight 407 and the surface property 408.

The create new color profile screen 500 also includes a colorimetric sensor selection screen 1202. The color accuracy control unit 315 displays, in the colorimetric sensor selection screen 1202, a determination result of the sensor usable for colorimetry determined in step S1012 illustrated in FIG. 10B.

That is, the color accuracy control unit 315 functions as a display control unit and controls the display so as to cause the colorimetric sensor selection screen 1202 to allow selection of only the colorimetric sensor usable for the colorimetry out of the colorimetric sensor 213 of the image forming apparatus 101 and the colorimetric sensor 271 of the external colorimetric apparatus 106.

FIG. 12 illustrates an example in which colorimetry cannot be performed with the colorimetric sensor 213 (inline) included in the image forming apparatus 101. The colorimetric sensor 213 cannot be designated as the colorimetric sensor 503, and accordingly, for example, the colorimetric sensor 213 is grayed out as the sensor unusable for colorimetry 901 so as not to be designated.

In step S1003, the user selects the colorimetric sensor 503 of the create new color profile screen 500 and pushes down the OK button 511. As a result, the color accuracy control unit 315 included in the information processing apparatus 103 accepts the colorimetric sensor 213 or 271 selected by the user in the colorimetric sensor 503 of the colorimetric sensor selection screen 1202 included in the create new color profile screen 500.

In step S705, the color accuracy control unit 315 instructs the print job control unit 311 to create a chart colorimetry job. At this time, the color accuracy control unit 315 imparts, to the chart colorimetry job, the colorimetric sensor selected in the colorimetric sensor 503 of the colorimetric sensor selection screen 1202 included in the create new color profile screen 500 as the colorimetric sensor setting.

In step S706, the print job control unit 311 transmits the chart colorimetry job to which the colorimetric sensor setting is imparted to the print job control unit 301 included in the image forming apparatus 101. The print job control unit 311 transmits the chart colorimetry job to the external colorimetric apparatus 106 when the colorimetric sensor 271 is selected in step S1003.

In step S707, the print job control unit 311 waits for the reception of the colorimetric value from the colorimetric unit 307 included in the image forming apparatus 101 or the colorimetric unit 321 included in the external colorimetric apparatus 106.

In step S1111 illustrated in FIG. 11B, the print job control unit 301 included in the image forming apparatus 101 receives the chart colorimetry job transmitted in step S706 from the print job control unit 311 included in the information processing apparatus 103.

In step S1112, the print job control unit 301 interprets the received chart colorimetry job and instructs the printer control unit 302 to print the chart colorimetry job. The printer control unit 302 controls printing, on the paper to be fed, of the chart in which the color patch is disposed.

In step S1113, the printer control unit 302 determines, based on the colorimetric sensor setting, whether the chart colorimetry job designates the colorimetric sensor 213 included in the image forming apparatus 101. When the colorimetric sensor 213 included in the image forming apparatus 101 is designated (Yes in S1113), the processing proceeds to step S1114. When the colorimetric sensor 213 included in the image forming apparatus 101 is not designated (No in S1113), the processing illustrated in FIG. 11B is completed.

In step S1114, the read control unit 306 instructs the colorimetric unit 307 to perform colorimetry on the chart colorimetry job, and the colorimetry on the chart is performed with the colorimetric sensor 213. The colorimetric sensor 213 performs colorimetry on the color patch disposed in the chart having been printed in step S1112.

In step S1115, the colorimetric unit 307 transmits the colorimetric value as the result of the colorimetry to the color accuracy control unit 315 included in the information processing apparatus 103.

In step S707 illustrated in FIG. 10A, the color accuracy control unit 315 included in the information processing apparatus 103 receives the colorimetric value from the colorimetric unit 307 or 321.

In the first case, the colorimetric sensor 213 (inline) included in the image forming apparatus 101 is designated in the colorimetric sensor setting designated in the colorimetric sensor 503 of the create new color profile screen 500 illustrated in FIG. 12. In this case, in step S707, the color accuracy control unit 315 receives the colorimetric value obtained by performing colorimetry on the chart with the colorimetric sensor 213 of the colorimetric unit 307 included in the image forming apparatus 101.

In the next case, the colorimetric sensor 271 included in the external colorimetric apparatus 106 is designated in the colorimetric sensor setting designated in the colorimetric sensor 503 of the create new color profile screen 500 illustrated in FIG. 12. In this case, in step S707, the color accuracy control unit 315 receives the colorimetric value obtained by performing colorimetry on the chart with the colorimetric sensor 271 of the colorimetric unit 321 included in the external colorimetric apparatus 106.

In step S708, the color accuracy control unit 315 creates the new color profile based on the received colorimetric value in step S707 and registers the color profile in the color profile management unit 313 included in the paper information management unit 312.

The color accuracy control unit 315 creates, as illustrated in FIGS. 6A and 6B, the color profile based on the colorimetric value for adjustment of the color to be printed by the image forming apparatus 101, associates the paper characteristics in step S703 and the color profile with each other, and resisters the paper characteristics and the color profile associated with each other.

According to the above-described present embodiment, even when the paper characteristics are determined after the new color profile creation flow has started, the printing system 110 can determine whether the colorimetry can be performed with the colorimetric sensor 213 included in the image forming apparatus 101 before the start of the new color profile creation flow.

### Third Embodiment

According to the second embodiment, the configuration for determining whether the colorimetry can be performed with the colorimetric sensor 213 included in the image forming apparatus 101 and allowing the user to designate the colorimetric sensor before the chart colorimetry job is submitted is described.

According to a third embodiment, a configuration for determining whether the colorimetry can be performed with the colorimetric sensor 213 included in the image forming apparatus 101 and allowing the color accuracy control unit 315 included in the information processing apparatus 103 to switch the colorimetric sensor before the chart colorimetry job is submitted is described.

A flowchart for determining whether the colorimetry can be performed with the colorimetric sensor 213 included in the image forming apparatus 101 and allowing the color accuracy control unit 315 included in the information processing apparatus 103 to switch the colorimetric sensor before the chart colorimetry job is submitted is described.

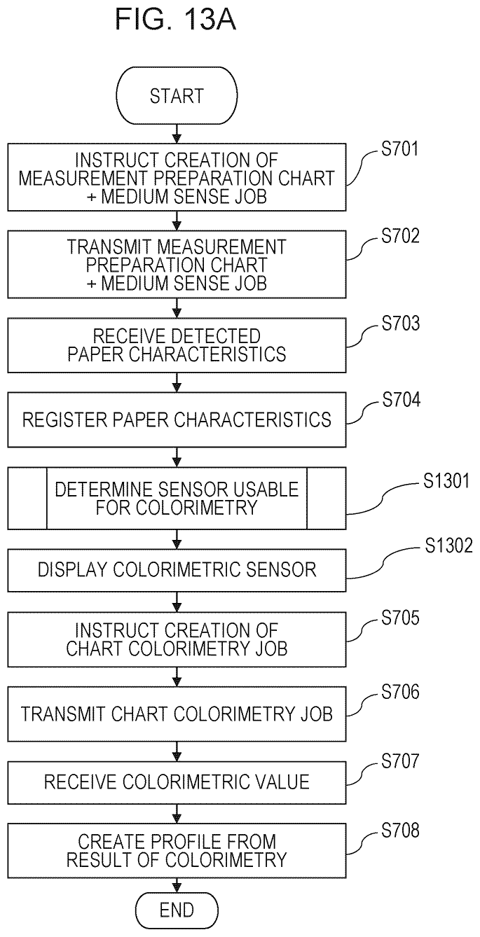

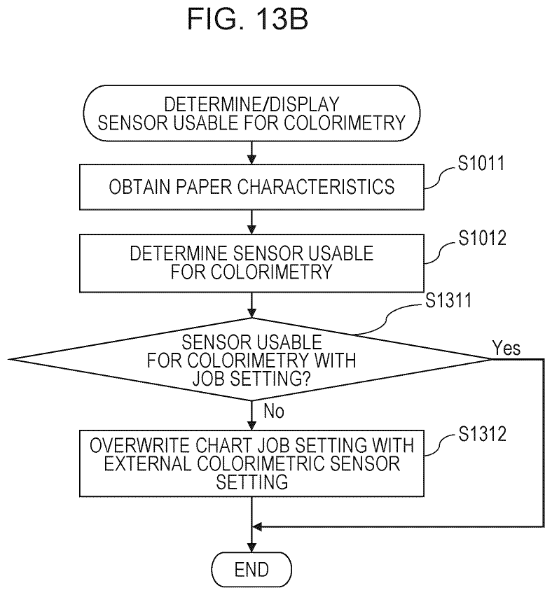

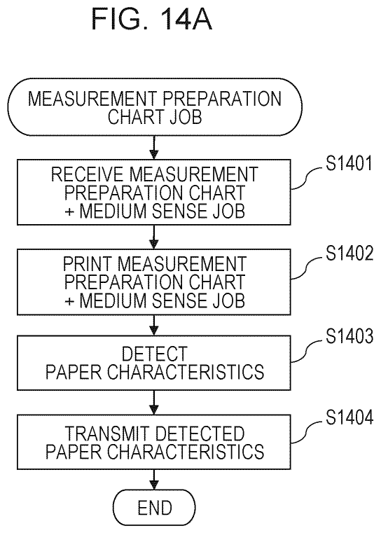

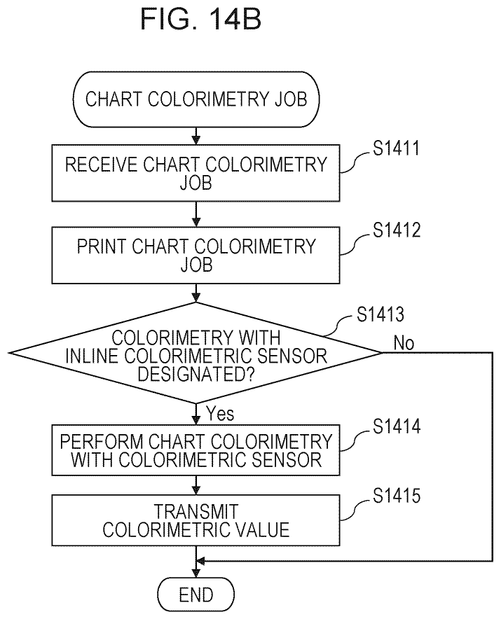

FIGS. 13A and 13B are flowcharts illustrating a processing method in the information processing apparatus 103. FIGS. 14A and 14B are flowcharts illustrating the processing method in the image forming apparatus 101.

Processing in the information processing apparatus 103 illustrated in FIGS. 13A and 13B is realized by execution in accordance with the program stored in the ROM 233 included in the information processing apparatus 103.

Processing in the image forming apparatus 101 illustrated in FIGS. 14A and 14B is realized by execution in accordance with the program stored in the ROM 203 included in the image forming apparatus 101.

When the OK button 511 is pushed down in the create new color profile screen 500 illustrated in FIG. 5A, a flow illustrated in FIG. 13A is started.

In step S701, the color accuracy control unit 315 included in the information processing apparatus 103 instructs the print job control unit 311 to create the measurement preparation chart job. At this time, the color accuracy control unit 315 imparts, to the measurement preparation chart job, the medium sense setting for detecting the paper characteristics.

In step S702, the print job control unit 311 included in the information

processing apparatus 103 transmits the measurement preparation chart job to which the medium sense setting is imparted to the print job control unit 301 included in the image forming apparatus 101.

In step S703, the print job control unit 311 included in the information processing apparatus 103 waits for reception of the paper characteristic information from the paper characteristic detection unit 308 included in the image forming apparatus 101.

In step S1401 illustrated in FIG. 14A, the print job control unit 301 included in the image forming apparatus 101 receives the measurement preparation chart job transmitted in step S702 from the print job control unit 311 included in the information processing apparatus 103.

In step S1402, the print job control unit 301 interprets the received measurement preparation chart job and instructs the printer control unit 302 to print the measurement preparation chart job.

In step S1403, the read control unit 306 included in the printer control unit 302 instructs the paper characteristic detection unit 308 to detect the paper characteristics because of the imparting, to the measurement preparation chart job, of the medium sense setting for detecting the paper characteristics. The paper characteristic detection unit 308 detects the paper characteristics of the paper to be fed with the medium sensor 212.

In step S1404, the paper characteristic detection unit 308 transmits the detected paper characteristic information to the paper information management unit 312 included in the information processing apparatus 103 and completes the processing illustrated in FIG. 14A.

In step S703 illustrated in FIG. 13A, the paper information management unit 312 included in the information processing apparatus 103 receives the paper characteristic information transmitted in step S1404 from the paper characteristic detection unit 308 included in the image forming apparatus 101.

In step S704, the paper information management unit 312 registers the received paper characteristic information in the paper characteristic management unit 314.

In step S1301, the color accuracy control unit 315 determines the sensor usable for colorimetry in accordance with the paper characteristic information registered in step S704.

FIG. 13B is a flowchart illustrating the details of step S1301 illustrated in FIG. 13A. In step S1011, the color accuracy control unit 315 included in the information processing apparatus 103 obtains the paper characteristic information of the object of the new color profile creation from the paper characteristic management unit 314.

In step S1012, the color accuracy control unit 315 determines the colorimetric sensor usable for colorimetry with respect to the colorimetric sensors 213 and 271 in accordance with the colorimetric sensor ability table 640 illustrated in FIG. 6C and the paper characteristic information having been obtained.

In step S1311, the color accuracy control unit 315 sets the colorimetric sensor 213 or 271 selected in the colorimetric sensor 503 of the create new color profile screen 500 illustrated in FIG. 5A as the colorimetric sensor setting. The color accuracy control unit 315 determines whether the colorimetric sensor of the above-described colorimetric sensor setting can be used for the colorimetry for the paper characteristic information obtained in step S1011 based on the determination result in step S1012.

That is, the color accuracy control unit 315 determines whether the colorimetric sensor 213 of the image forming apparatus 101 or the colorimetric sensor 271 of the external colorimetric apparatus 106 selected in the colorimetric sensor 503 illustrated in FIG. 5A can be used for the colorimetry for the obtained paper characteristic information.

When it is determined that the selected colorimetric sensor is unusable for the colorimetry (No in S1311), the processing proceeds to step S1312. When it is determined that the selected colorimetric sensor can be used for the colorimetry (Yes in S1311), the processing illustrated in FIG. 13B is completed.

In step S1312, the color accuracy control unit 315 overwrites the colorimetric sensor setting with the setting of the colorimetric sensor 271 of the external colorimetric apparatus 106.

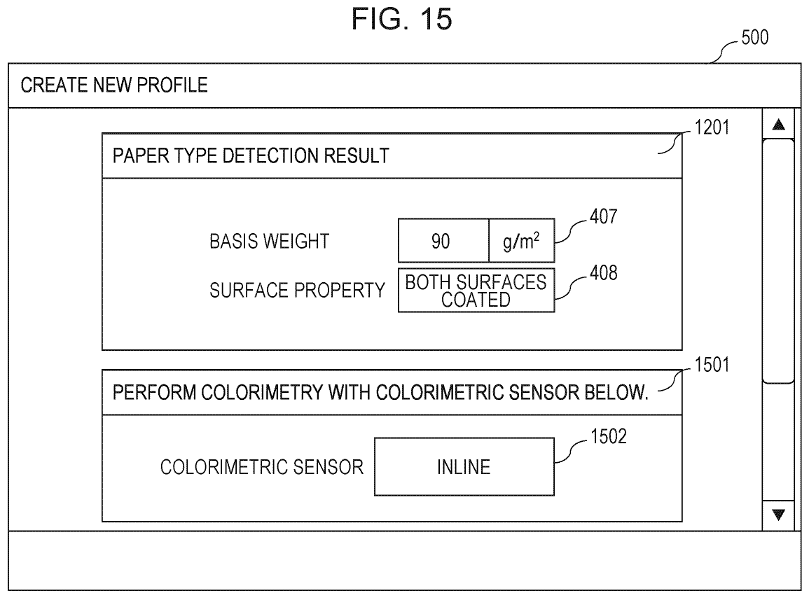

In step S1302 illustrated in FIG. 13A, the color accuracy control unit 315 displays the create new color profile screen 500 illustrated in FIG. 15. The create new color profile screen 500 includes the paper characteristic detection result screen 1201. The color accuracy control unit 315 displays the paper characteristic information received in step S703 in the paper characteristic detection result screen 1201 as the basis weight 407 and the surface property 408.

The create new color profile screen 500 also includes a paper characteristic detection result screen 1501. The color accuracy control unit 315 displays the colorimetric sensor of the colorimetric sensor setting as a colorimetric sensor 1502 in the paper characteristic detection result screen 1501.

FIG. 15 illustrates an example in which, when it is determined that the colorimetric sensor 213 (inline) included in the image forming apparatus 101 can be used for the colorimetry (Yes in S1311), the colorimetric sensor 213 (inline) is displayed as the colorimetric sensor 1502.

However, when it is determined that the colorimetric sensor 213 (inline) included in the image forming apparatus 101 is unusable for the colorimetry (No in S1311), the colorimetric sensor 271 included in the external colorimetric apparatus 106 is displayed as the colorimetric sensor 1502.

In step S705, the color accuracy control unit 315 instructs the print job control unit 311 to create a chart colorimetry job. At this time, the color accuracy control unit 315 imparts the colorimetric sensor setting to the chart colorimetry job.

In step S706, the print job control unit 311 transmits the chart colorimetry job to which the colorimetric sensor setting is imparted to the print job control unit 301 included in the image forming apparatus 101. The print job control unit 311 also transmits the chart colorimetry job to the external colorimetric apparatus 106 when the chart colorimetry job setting is the setting of the colorimetric sensor 271.

In step S707, the print job control unit 311 waits for the reception of the colorimetric value from the colorimetric unit 307 included in the image forming apparatus 101 or the colorimetric unit 321 included in the external colorimetric apparatus 106.

In step S1411 illustrated in FIG. 14B, the print job control unit 301 included in the image forming apparatus 101 receives the chart colorimetry job transmitted in step S706 from the print job control unit 311 included in the information processing apparatus 103.

In step S1412, the print job control unit 301 interprets the received chart colorimetry job and instructs the printer control unit 302 to print the chart colorimetry job. The printer control unit 302 controls printing, on the paper to be fed, of the chart in which the color patch is disposed.

In step S1413, the printer control unit 302 determines, based on the colorimetric sensor setting of the chart colorimetry job, whether the chart colorimetry job designates the colorimetric sensor 213 included in the image forming apparatus 101. When the colorimetric sensor 213 included in the image forming apparatus 101 is designated (Yes in S1413), the processing proceeds to step S1414. When the colorimetric sensor 213 included in the image forming apparatus 101 is not designated (No in S1413), the processing illustrated in FIG. 14B is completed.

In step S1414, the read control unit 306 instructs the colorimetric unit 307 to perform colorimetry on the chart colorimetry job, and the colorimetry on the chart is executed with the colorimetric sensor 213. The colorimetric sensor 213 performs colorimetry on the color patch disposed in the chart having been printed in step S1412.

In step S1415, the colorimetric unit 307 transmits the colorimetric value as the result of the colorimetry to the color accuracy control unit 315 included in the information processing apparatus 103.

In step S707 illustrated in FIG. 13A, the color accuracy control unit 315 included in the information processing apparatus 103 receives the colorimetric value from the colorimetric unit 307 or 321.

In the first case, the colorimetric sensor 213 (inline) included in the image forming apparatus 101 is set as the colorimetric sensor setting. In this case, in step S707, the color accuracy control unit 315 receives the colorimetric value obtained by performing colorimetry on the chart with the colorimetric sensor 213 of the colorimetric unit 307 included in the image forming apparatus 101.

In the next case, the colorimetric sensor 271 included in the external colorimetric apparatus 106 is set as the colorimetric sensor setting. In this case, in step S707, the color accuracy control unit 315 receives the colorimetric value obtained by performing colorimetry on the chart with the colorimetric sensor 271 of the colorimetric unit 321 included in the external colorimetric apparatus 106.

In step S708, the color accuracy control unit 315 creates the new color profile based on the received colorimetric value in step S707 and registers the color profile in the color profile management unit 313 included in the paper information management unit 312.

The color accuracy control unit 315 creates, as illustrated in FIGS. 6A and 6B, the color profile based on the colorimetric value for adjustment of the color to be printed by the image forming apparatus 101, associates the paper characteristics in step S703 and the color profile with each other, and resisters the paper characteristics and the color profile associated with each other.

According to the above-described present embodiment, when the paper characteristics are determined after the new color profile creation flow has started, the printing system 110 determines whether the colorimetry can be performed with the colorimetric sensor 213 included in the image forming apparatus 101 before the start of the new color profile creation flow. Thus, the color accuracy control unit 315 included in the information processing apparatus 103 can switch the colorimetric sensor.

### Fourth Embodiment

According to the third embodiment, a configuration for determining whether the colorimetry can be performed with the colorimetric sensor 213 included in the image forming apparatus 101 and allowing the color accuracy control unit 315 included in the information processing apparatus 103 to switch the colorimetric sensor before the chart colorimetry job is submitted is described. In contrast, in a configuration without the measurement preparation chart job, whether the colorimetry can be performed with the colorimetric sensor 213 included in the image forming apparatus 101 cannot be determined before the chart colorimetry job is submitted.

According to a fourth embodiment, a configuration for detecting the paper characteristics by the chart colorimetry job, determining whether the colorimetry can be performed with the colorimetric sensor 213 included in the image forming apparatus 101, and allowing the color accuracy control unit 315 included in the information processing apparatus 103 to switch the colorimetric sensor is described.

A flowchart for detecting the paper characteristics by the chart colorimetry job, determining whether the colorimetry can be performed with the colorimetric sensor 213 included in the image forming apparatus 101, and allowing the color accuracy control unit 315 included in the information processing apparatus 103 to switch the colorimetric sensor is described.

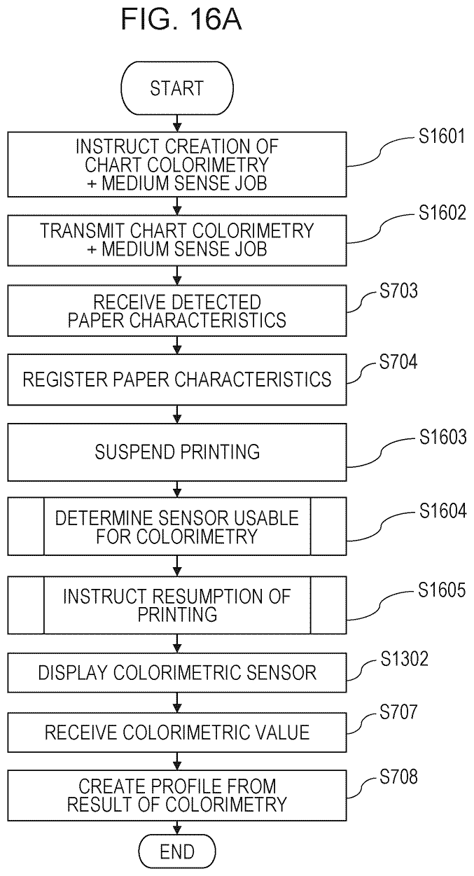

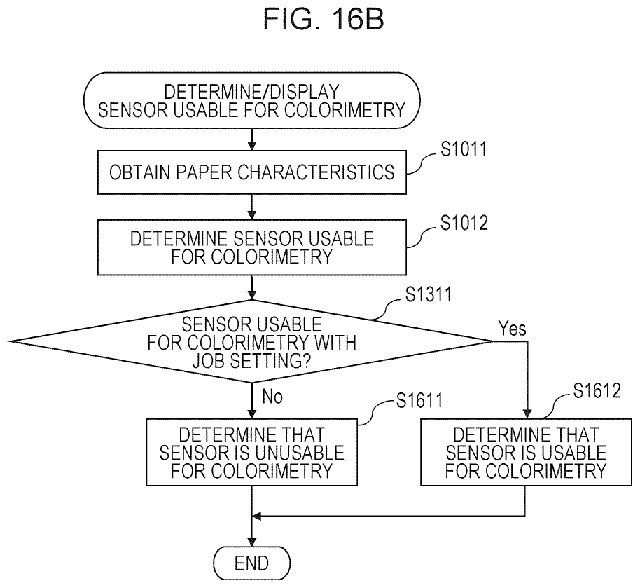

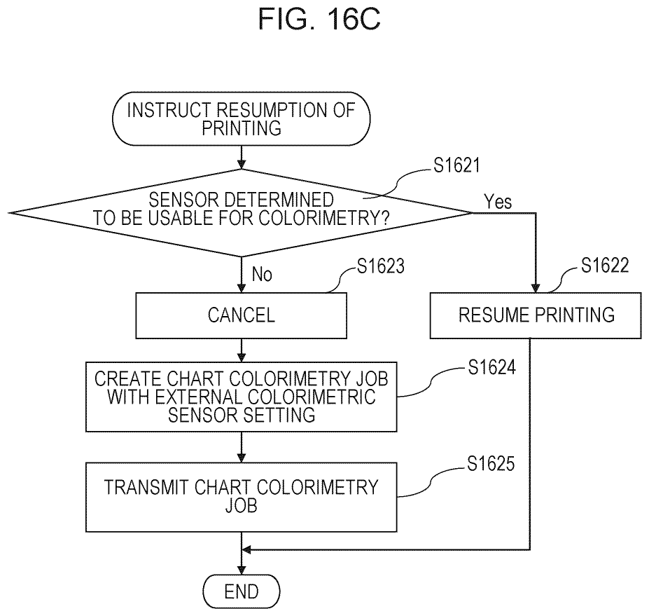

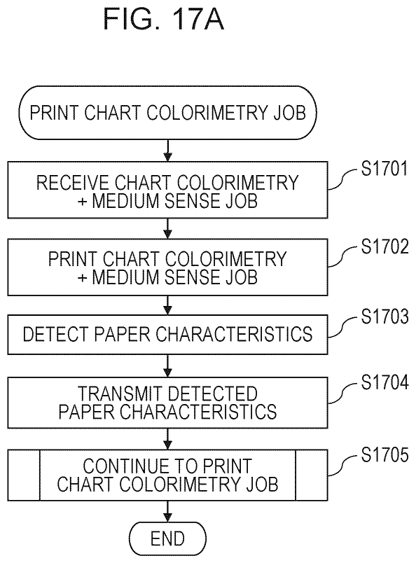

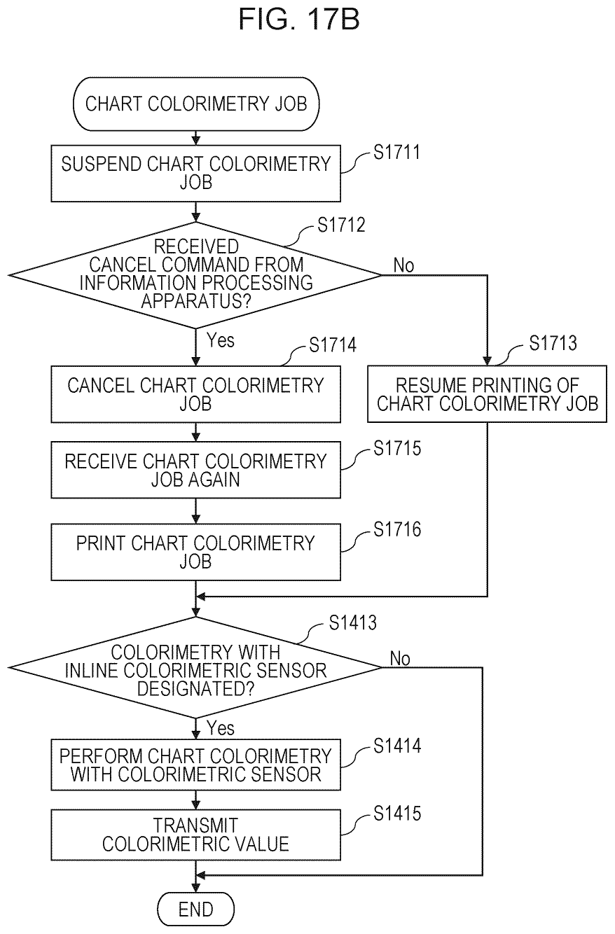

FIGS. 16A to 16C are flowcharts illustrating a processing method in the information processing apparatus 103. FIGS. 17A and 17B are flowcharts illustrating the processing method in the image forming apparatus 101.

Processing in the information processing apparatus 103 illustrated in FIGS. 16A to 16C is realized by execution in accordance with the program stored in the ROM 233 included in the information processing apparatus 103. Processing in the image forming apparatus 101 illustrated in FIGS. 17A and 17B is realized by execution in accordance with the program stored in the ROM 203 included in the image forming apparatus 101.

When the OK button 511 is pushed down in the create new color profile screen 500 illustrated in FIG. 5A, a flow illustrated in FIG. 16A is started.

In step S1601, the color accuracy control unit 315 included in the information processing apparatus 103 instructs the print job control unit 311 to create the chart colorimetry job. At this time, the color accuracy control unit 315 imparts, to the chart colorimetry job, the medium sense setting for detecting the paper characteristics. The color accuracy control unit 315 also imparts, to the chart colorimetry job, the colorimetric sensor setting designated in the colorimetric sensor 503 of the create new color profile screen 500 illustrated in FIG. 5A.

In step S1602, the print job control unit 311 included in the information processing apparatus 103 transmits the chart colorimetry job to which the medium sense setting and the colorimetric sensor setting are imparted to the print job control unit 301 included in the image forming apparatus 101.

This chart colorimetry job is a job provided for detection of the paper characteristics of the paper to be fed performed by the paper characteristic detection unit 308 of the image forming apparatus 101, control of printing of the chart in which the color patch is disposed in the paper to be fed performed by the print control unit 303 of the image forming apparatus 101, and the instruction of colorimetry on the color patch disposed in the printed chart performed by the colorimetric unit 307 of the image forming apparatus 101.

The print job control unit 311 functions as an instruction unit. Based on the instruction by the single user operation, with respect to the image forming apparatus 101, the print job control unit 311 instructs the paper characteristic detection unit 308 of the image forming apparatus 101 to detect the paper characteristics of the paper to be fed, the print control unit 303 of the image forming apparatus 101 to control the printing, on the paper to be fed, of the chart in which the color patch is disposed, and the colorimetric unit 307 of the image forming apparatus 101 to perform the colorimetry on the color patch disposed in the printed chart performed.

The above-described single user operation is the operation of pushing down the OK button 511 in the create new color profile screen 500 illustrated in FIG. 5A and is the instruction including the selection of the colorimetric sensor 503 illustrated in FIG. 5A.

The selection of the colorimetric sensor 503 illustrated in FIG. 5A is selection of either the colorimetric sensor 213 of the image forming apparatus 101 or the colorimetric sensor 271 of the external colorimetric apparatus 106.

In step S703, the print job control unit 311 included in the information processing apparatus 103 waits for reception of the paper characteristic information from the paper characteristic detection unit 308 included in the image forming apparatus 101.

In step S1701 illustrated in FIG. 17A, the print job control unit 301 included in the image forming apparatus 101 receives the chart colorimetry job transmitted in step S1602 from the print job control unit 311 included in the information processing apparatus 103.

In step S1702, the print job control unit 301 interprets the received chart colorimetry job and instructs the printer control unit 302 to print the chart colorimetry job.

In step S1703, the read control unit 306 included in the printer control unit 302 instructs the paper characteristic detection unit 308 to detect the paper characteristics because of the imparting, to the chart colorimetry job, of the medium sense setting for detecting the paper characteristics. The paper characteristic detection unit 308 detects the paper characteristics of the paper to be fed with the medium sensor 212.

In step S1704, the paper characteristic detection unit 308 transmits the detected paper characteristic information to the paper information management unit 312 included in the information processing apparatus 103.

In step S1705, the printer control unit 302 continues to print the chart colorimetry job. The details of step S1705 are described later with reference to the flowchart illustrated in FIG. 17B.

In step S703 illustrated in FIG. 16A, the paper information management unit 312 included in the information processing apparatus 103 receives the paper characteristic information transmitted in step S1704 from the paper characteristic detection unit 308 included in the image forming apparatus 101.

In step S704, the paper information management unit 312 registers the received paper characteristic information in the paper characteristic management unit 314.

In step S1603, the print job control unit 311 transmits a printing suspension command to the print job control unit 301 included in the image forming apparatus 101.

In step S1711 illustrated in FIG. 17B, the print job control unit 301 included in the image forming apparatus 101 receives the printing suspension command and suspends the chart colorimetry job.

In step S1604 illustrated in FIG. 16A, the color accuracy control unit 315 included in the information processing apparatus 103 determines the sensor usable for colorimetry.

FIG. 16B is the flowchart illustrating the details of step S1604 illustrated in FIG. 16A. In step S1011, the color accuracy control unit 315 included in the information processing apparatus 103 obtains the paper characteristic information of the object of the new color profile creation from the paper characteristic management unit 314.

In step S1012, the color accuracy control unit 315 determines the colorimetric sensor usable for colorimetry with respect to the colorimetric sensors 213 and 271 in accordance with the colorimetric sensor ability table 640 illustrated in FIG. 6C and the paper characteristic information having been obtained.

In step S1311, the color accuracy control unit 315 sets the colorimetric sensor 213 or 271 selected in the colorimetric sensor 503 of the create new color profile screen 500 illustrated in FIG. 5A as the colorimetric sensor setting. The color accuracy control unit 315 determines whether the colorimetric sensor of the above-described colorimetric sensor setting can be used for the colorimetry for the paper characteristic information obtained in step S1011 based on the determination result in step S1012.

That is, the color accuracy control unit 315 determines whether the colorimetric sensor 213 of the image forming apparatus 101 or the colorimetric sensor 271 of the external colorimetric apparatus 106 selected in the colorimetric sensor 503 illustrated in FIG. 5A can be used for the colorimetry for the obtained paper characteristic information.

When it is determined that the selected colorimetric sensor is unusable for the colorimetry (No in S1311), the processing proceeds to step S1611. When it is determined that the selected colorimetric sensor can be used for the colorimetry (Yes in S1311), the processing proceeds to step S1612.

In step S1611, the color accuracy control unit 315 determines, as a determination result, that the sensor is unusable for the colorimetry.

In step S1612, the color accuracy control unit 315 determines, as the determination result, that the sensor can be used for the colorimetry.

In step S1605 illustrated in FIG. 16A, the print job control unit 311 starts a printing resumption instruction process.

FIG. 16C is the flowchart illustrating the details of step S1605 illustrated in FIG. 16A. In step S1621, the print job control unit 311 determines whether the determination result in step S1611 or S1612 illustrated in FIG. 16B is that the colorimetric sensor can be used for the colorimetry. When the determination result is that the colorimetric sensor can be used for the colorimetry (Yes in S1621), the processing proceeds to step S1622. When the determination result is that the colorimetric sensor is unusable for the colorimetry (No in S1621), the processing proceeds to step S1623.

In step S1622, the print job control unit 311 transmits a printing resumption command to the print job control unit 301 included in the image forming apparatus 101 and completes the processing illustrated in FIG. 16C.

In step S1623, the print job control unit 311 functions as a transmission unit and transmits a chart colorimetry job cancel command to the print job control unit 301 included in the image forming apparatus 101.

In step S1624, the print job control unit 311 creates again the chart colorimetry job to which the colorimetric sensor setting of the colorimetric sensor 271 of the external colorimetric apparatus 106 is imparted.

In step S1625, the print job control unit 311 transmits the chart colorimetry job having been created again to the print job control unit 301 included in the image forming apparatus 101 and completes the processing illustrated in FIG. 16C.

This chart colorimetry job is a job provided for control of printing of the chart in which the color patch is disposed in the paper to be fed performed by the print control unit 303 of the image forming apparatus 101 and for the instruction of the colorimetry on the color patch disposed in the printed chart performed by the colorimetric sensor 213 of the image forming apparatus 101.

Next, in step S1302 illustrated in FIG. 16A, the color accuracy control unit 315 displays the create new color profile screen 500 illustrated in FIG. 15. The create new color profile screen 500 includes the paper characteristic detection result screen 1201. The color accuracy control unit 315 displays the paper characteristic information received in step S703 in the paper characteristic detection result screen 1201 as the basis weight 407 and the surface property 408.

The create new color profile screen 500 also includes the paper characteristic detection result screen 1501. The color accuracy control unit 315 displays the colorimetric sensor of the colorimetric sensor setting as the colorimetric sensor 1502 in the paper characteristic detection result screen 1501.

FIG. 15 illustrates an example in which, when it is determined that the colorimetric sensor 213 (inline) included in the image forming apparatus 101 can be used for the colorimetry (Yes in S1621), the colorimetric sensor 213 (inline) is displayed as the colorimetric sensor 1502.

However, when it is determined that the colorimetric sensor 213 (inline)

included in the image forming apparatus 101 is unusable for the colorimetry (No in

S1621), the colorimetric sensor 271 included in the external colorimetric apparatus 106 is displayed as the colorimetric sensor 1502.

In step S707, the print job control unit 311 waits for the reception of the colorimetric value from the colorimetric unit 307 included in the image forming apparatus 101 or the colorimetric unit 321 included in the external colorimetric apparatus 106.

In step S1712 illustrated in FIG. 17B, the print job control unit 301 included in the image forming apparatus 101 waits for the reception of the command of step S1622 or S1623 illustrated in FIG. 16C for the chart colorimetry job being suspended from the print job control unit 311.

The print job control unit 301 causes the processing to proceed to step S1714 when the chart colorimetry job cancel command in step S1623 is received. The print job control unit 301 causes the processing to proceed to step S1713 when the printing resumption command in step S1622 is received.

In step S1713, the printer control unit 302 resumes the printing of the chart based on the chart colorimetry job being suspended and causes the processing to proceed to step S1413. The printer control unit 302 controls the printing, on the paper to be fed, of the chart in which the color patch is disposed.

In step S1714, the print job control unit 301 cancels the printing of the chart colorimetry job being suspended.

In step S1715, the print job control unit 301 receives the chart colorimetry job transmitted in step S1625 illustrated in FIG. 16C from the print job control unit 311 included in the information processing apparatus 103.

In step S1716, the print job control unit 301 interprets the received chart colorimetry job and instructs the printer control unit 302 to print the chart colorimetry job. The printer control unit 302 controls the printing, on the paper to be fed, of the chart in which the color patch is disposed.

In step S1413, the printer control unit 302 determines, based on the colorimetric sensor setting of the chart colorimetry job, whether the chart colorimetry job designates the colorimetric sensor 213 included in the image forming apparatus 101. When the colorimetric sensor 213 included in the image forming apparatus 101 is designated (Yes in S1413), the processing proceeds to step S1414. When the colorimetric sensor 213 included in the image forming apparatus 101 is not designated (No in S1413), the processing illustrated in FIG. 17B is completed.

In step S1414, the read control unit 306 instructs the colorimetric unit 307 to perform colorimetry on the chart colorimetry job, and the colorimetry of the chart is executed with the colorimetric sensor 213. The colorimetric sensor 213 performs colorimetry on the color patch disposed in the chart having been printed in step S1713.

In step S1415, the colorimetric unit 307 transmits the colorimetric value as the result of the colorimetry to the color accuracy control unit 315 included in the information processing apparatus 103.

In step S707 illustrated in FIG. 16A, the color accuracy control unit 315 included in the information processing apparatus 103 receives the colorimetric value from the colorimetric unit 307 or 321.

In the first case, the colorimetric sensor 213 (inline) included in the image forming apparatus 101 is set as the colorimetric sensor setting. In this case, in step S707, the color accuracy control unit 315 receives the colorimetric value obtained by performing colorimetry on the chart with the colorimetric sensor 213 of the colorimetric unit 307 included in the image forming apparatus 101.

In the next case, the colorimetric sensor 271 included in the external colorimetric apparatus 106 is set as the colorimetric sensor setting. In this case, in step S707, the color accuracy control unit 315 receives the colorimetric value obtained by performing colorimetry on the chart with the colorimetric sensor 271 of the colorimetric unit 321 included in the external colorimetric apparatus 106.

In step S708, the color accuracy control unit 315 creates the new color profile based on the received colorimetric value in step S707 and registers the color profile in the color profile management unit 313 included in the paper information management unit 312.

The color accuracy control unit 315 creates, as illustrated in FIGS. 6A and 6B, the color profile based on the colorimetric value for adjustment of the color to be printed by the image forming apparatus 101, associates the paper characteristics in step S703 and the color profile with each other, and resisters the paper characteristics and the color profile associated with each other.

According to the present embodiment having been described, the printing system 110 can detect the paper characteristics by the chart colorimetry job, determine whether the colorimetry can be performed with the colorimetric sensor 213 included in the image forming apparatus 101, and allows the color accuracy control unit 315 included in the information processing apparatus 103 to switch the colorimetric sensor.

According to the present disclosure, the paper characteristics and the color profile can be registered based on the instruction by the single user operation.

### Other Embodiments

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-062894 filed Apr. 9, 2024, which is hereby incorporated by reference herein in its entirety.

What is claimed is:

1. A printing system comprising:
an image forming apparatus; and
an information processing apparatus,
wherein the image forming apparatus includes
a unit configured to detect a paper characteristic that detects the paper characteristic of paper to be fed,
a unit configured to control printing that controls the printing, on the paper to be fed, of a chart in which a color patch is disposed, and
a unit configured to perform colorimetry that performs the colorimetry on the color patch disposed in the printed chart, and
wherein the information processing apparatus includes
a unit configured to instruct that instructs, based on an instruction by a user, the image forming apparatus to detect the paper characteristic of the paper to be fed by using the unit configured to detect a paper characteristic of the image forming apparatus, to print the chart in which the color patch is disposed, and to perform the colorimetry on the color patch disposed in the printed chart,
a unit configured to receive that receives, from the image forming apparatus, the detected paper characteristic and a result of the colorimetry, and
a unit configured to register that creates, based on the result of the colorimetry, a color profile for adjustment of a color to be printed by the image forming apparatus, associates the detected paper characteristic and the color profile with each other, and resisters the paper characteristic and the color profile associated with each other.

2. The printing system according to claim 1,
wherein the instruction by on an operation of the user includes selection of either the unit configured to perform colorimetry of the image forming apparatus or an external unit configured to perform colorimetry, and
wherein the unit configured to register creates the color profile based on the result of the colorimetry performed on the color patch with the unit configured to perform colorimetry of the image forming apparatus when the unit configured to perform colorimetry of the image forming apparatus is selected, and
the unit configured to register creates the color profile based on the result of the colorimetry performed on the color patch with the external unit configured to perform colorimetry when the external unit configured to perform colorimetry is selected.

3. The printing system according to claim 2,
wherein the unit configured to instruct transmits information on the selection to the image forming apparatus, and
wherein the unit configured to perform colorimetry of the image forming apparatus performs the colorimetry on the color patch disposed in the printed chart when the unit configured to perform colorimetry of the image forming apparatus is selected.

4. The printing system according to claim 1,
wherein the unit configured to instruct transmits a first job for the instruction of the detection of the paper characteristic to the image forming apparatus, and
wherein the unit configured to receive receives the detected paper characteristic from the image forming apparatus,
wherein the unit configured to instruct transmits a second job for the control of the printing of the chart and the instruction of the colorimetry to the image forming apparatus, and
wherein the unit configured to receive receives the result of the colorimetry from the image forming apparatus.

5. The printing system according to claim 4,
wherein the information processing apparatus further includes
a unit configured to determine that determines whether the unit configured to perform colorimetry of the image forming apparatus is usable for the colorimetry with respect to the detected paper characteristic and whether an external unit configured to perform colorimetry is usable for the colorimetry with respect to the detected paper characteristic, and
a unit configured to control display that controls so as to display a selection screen which allows selection of only a unit configured to perform colorimetry able to perform the colorimetry out of the unit configured to perform colorimetry of the image forming apparatus and the external unit configured to perform colorimetry,
wherein the unit configured to instruct transmits the second job including information on selection in the selection screen to the image forming apparatus,
wherein the unit configured to perform colorimetry of the image forming apparatus performs the colorimetry on the color patch disposed in the printed chart when the unit configured to perform colorimetry of the image forming apparatus is selected, and
wherein the unit configured to register creates the color profile based on the result of the colorimetry performed on the color patch with the unit configured to perform colorimetry of the image forming apparatus when the unit configured to perform colorimetry of the image forming apparatus is selected, and
the unit configured to register creates the color profile based on the result of the colorimetry performed on the color patch with the external unit configured to perform colorimetry when the external unit configured to perform colorimetry is selected.

6. The printing system according to claim 1,
wherein the instruction by an operation of the user includes selection of either the unit configured to perform colorimetry of the image forming apparatus or an external unit configured to perform colorimetry,
wherein the information processing apparatus further includes a unit configured to determine that determines whether the unit configured to perform colorimetry of the image forming apparatus or the external unit configured to perform colorimetry having been selected is usable for the colorimetry with respect to the detected paper characteristic, and
wherein the unit configured to register creates the color profile based on the result of the colorimetry performed on the color patch by the unit configured to perform colorimetry of the image forming apparatus or the external unit configured to perform colorimetry having been selected when the unit configured to determine determines that the colorimetry is able to be performed.

7. The printing system according to claim 6,
wherein the unit configured to register creates the color profile based on the result of the colorimetry performed on the color patch with the external unit configured to perform colorimetry when the unit configured to determine determines that the colorimetry is unable to be performed.

8. The printing system according to claim 1,
wherein the unit configured to instruct transmits a third job for the detection of the paper characteristic, control of the printing of the chart, and an instruction of the colorimetry to the image forming apparatus.

9. The printing system according to claim 8,
wherein the instruction by an operation of the user includes selection of either the unit configured to perform colorimetry of the image forming apparatus or an external unit configured to perform colorimetry,
wherein the information processing apparatus further includes a unit configured to determine that determines whether the unit configured to perform colorimetry of the image forming apparatus or the external unit configured to perform colorimetry having been selected is usable for the colorimetry with respect to the detected paper characteristic, and
wherein the unit configured to register creates the color profile based on the result of the colorimetry performed on the color patch by the unit configured to perform colorimetry of the image forming apparatus or the external unit configured to perform colorimetry having been selected when the unit configured to determine determines that the colorimetry is able to be performed.

10. The printing system according to claim 9,
wherein the information processing apparatus further includes a unit configured to transmit that transmits, when the unit configured to determine determines that the colorimetry is unable to be performed, to the image forming apparatus a cancel command for the third job and a fourth job for control of the printing of the chart and an instruction to perform the colorimetry with the external unit configured to perform colorimetry, and
wherein the unit configured to register creates the color profile based on the result of the colorimetry performed on the color patch with the external unit configured to perform colorimetry when the unit configured to determine determines that the colorimetry is unable to be performed.

11. The printing system according to claim 10,
wherein the unit configured to transmit transmits a printing suspension command to the image forming apparatus after the unit configured to receive has received the detected paper characteristic, and the unit configured to transmit transmits a printing resumption command to the image forming apparatus when the unit configured to determine determines that the colorimetry is able to be performed.

12. An information processing apparatus comprising:
a unit configured to instruct that instructs, based on an instruction by a user, an image forming apparatus to detect a paper characteristic of paper to be fed by using a unit configured to detect a paper characteristic of the image forming apparatus, to print a chart in which a color patch is disposed, and to perform colorimetry on the color patch disposed in the printed chart,
a unit configured to receive that receives, from the image forming apparatus, the detected paper characteristic and a result of the colorimetry, and
a unit configured to register that creates, based on the result of the colorimetry, a color profile for adjustment of a color to be printed by the image forming apparatus, associates the detected paper characteristic and the color profile with each other, and resisters the paper characteristic and the color profile associated with each other.

13. A non-transitory computer readable storage medium for storing a program causing an information processing apparatus to perform a method, the method comprising:
instructing that instructs, based on an instruction by a user, an image forming apparatus to detect a paper characteristic of paper to be fed by using a unit configured to detect a paper characteristic of the image forming apparatus, to print a chart in which a color patch is disposed, and to perform colorimetry on the color patch disposed in the printed chart,
receiving that receives, from the image forming apparatus, the detected paper characteristic and a result of the colorimetry, and
registering that creates, based on the result of the colorimetry, a color profile for adjustment of a color to be printed by the image forming apparatus, associates the detected paper characteristic and the color profile with each other, and resisters the paper characteristic and the color profile associated with each other.
